(19) United States
(12) Patent Application Publication
(10) Pub. No.: US 2018/0079843 A1
(43) Pub. Date: Mar. 22, 2018

(54) METALLOCENE COMPLEX WITH A HETEROATOM-CONTAINING PI-LIGAND AND PREPARATION METHOD THEREFOR, CATALYST SYSTEM CONTAINING THE SAME AND USE THEREOF

(71) Applicant: PetroChina Company Limited, Beijing (CN)

(72) Inventors: Shixuan XIN, Beijing (CN); Xiaomei LANG, Beijing (CN); Shan XUE, Beijing (CN); Xinle LI, Beijing (CN); Hongfan HU, Beijing (CN); Xin SUN, Beijing (CN); Xueqin ZHANG, Beijing (CN); Shengyuan ZHOU, Beijing (CN); Yin RAN, Beijing (CN); Botian LI, Beijing (CN); Bochao ZHU, Beijing (CN); Junji JIA, Beijing (CN); Jingping QU, Beijing (CN); Yuming SONG, Beijing (CN); Yamei XIE, Beijing (CN); Ying MU, Beijing (CN); Wei GAO, Beijing (CN); Jinglong LIU, Beijing (CN)

(21) Appl. No.: 15/548,793

(22) PCT Filed: Feb. 5, 2016
(86) PCT No.: PCT/CN2016/073644

§ 371 Date: Dec. 6, 2017

(30) Foreign Application Priority Data
Feb. 6, 2015 (CN) 201510064976.X
Feb. 6, 2015 (CN) 201510064977.4

(51) Int. Cl. C08F 110/06; C07F 7/08

(52) U.S. Cl. CPC C08F 110/06; C07F 7/0812

(57) ABSTRACT

The present invention relates to a metallocene complex with a heteroatom-containing π-ligand, having a chemical structure represented by formula (I) as below:

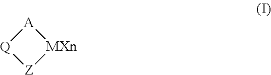

wherein M is a transition metal element from Group 3, Group 4, Group 5 and Group 6 in the periodic table, including lanthanides and actinides; X, being the same as or different from each other, is selected from hydrogen, halogen, an alkyl group R, an alkoxyl group OR, a mercapto group SR, a carboxyl group OCOR, an amino group NR₂, a phosphino group PR₂, —OR^{o}O— and OSO₂CF₃; n is an integer from 1 to 4 and is not zero; the charge number resulted from multiplying n by the charge number of X equals to the charge number of the central metal atom M minus 2; Q is a divalent radical; A is a π-ligand; and Z is a π-ligand;
the process for producing the same; a catalyst system of the same; and use of the catalyst system.

### TECHNICAL FIELD

The present invention belongs to the field of catalyst, and in particular relates to a metallocene complex with heteroatom-containing π-ligands, a catalyst system having the metallocene complex as the core component, processes for preparing the metallocene complex and the catalyst system, and the use of the catalyst system in the polymerization of α-olefins.

### BACKGROUND

Organometallic complex formed of cyclopentadiene and its derivatives in a π-ligand form, known as metallocene complex, especially metallocene complex of transition metals in Group 3 and Group 4, has a very high catalytic polymerization activity for olefins when coupled with proper activating agents. A wide variety of applications were found in catalytic ethylene polymerization (H. G. Alte et al. Chemcal Reviews 2000, 100, 1205. Metallocene-Based Polyolefins. Preparation, Properties and Technology; Scheirs, J.; Kaminsky, W., Eds.; Wiley: New York, 1999). Group 4 transition metallocene complexes with a special symmetric structure not only have high activity but also extremely high regioselectivity and stereoselectivity, and have been successfully used in stereospecific polymerization of propylene to produce isotactic polypropylenes (iPP) and syndiotactic polypropylenes (sPP) (Luigi Resconi, Luigi Cavallo, Anna Fait, and Fabrizio Piemontesi, Chemical Reviews 2000, 100, 1253).

Due to the chemistry of abundant substitution on the indene ring (Halterman, R. L. Chem. Rev. 1992, 92, 965), unlimited combination of substituents at positions 1 to 7 on the indene ring, and the potential scientific, technical, and commercial values thereof, great attention has been paid in the past thirty years to Group 3 and Group 4 metallocene complex catalysts for olefin polymerization based mainly on substituted indenes, especially bridged Group 4 metallocene complex catalysts for olefin polymerization (H. H. Brintzinger, D. Fischer, R. Muelhaupt, B. Rieger, R. M. Waymouth, Angew. Chem., Int. Ed. Engl. 1995, 34, 1143. Luigi Resconi, Luigi Cavallo, Anna Fait, and Fabrizio Piemontesi, Chemical Reviews 2000, 100, 1253). Group 4 transition metallocene complexes having a bridged, substituted indene as ligand has actually become dominant in metallocene chemistry, providing not only plenty of strong experimental evidences for the development of organometallic chemistry theories, but also various catalysts having special properties in the polyolefin industry and for high-selectivity organic synthetic chemistry (Metallocenes: Synthesis, Reactivity, Applications, A. Togni and R. L. Halterman Eds, Wiley, 1998. Metallocenes in Regio- and Stereoselective Synthesis, T. Takahashi Ed, Springer, 2005). In brief, the development of metallocene complex catalysts has significantly contributed to elucidation of mechanisms in α-olefin stereospecific polymerization, diversification of olefin materials of different varieties and specifications, and providing novel olefin materials having special properties (Advances in Organometallic Chemistry; F. G. A. Stone; R. West; Eds.; Academic Press: New York, 1980. Transition Metals and Organometallics as Catalysts for Olefin Polymerization; W. Kaminsky; H. Sinn, Eds.; Springer-Verlag: Berlin, 1988. Metallocene-Based Polyolefin; J. Scheirs and W. Kaminsky Eds. Wiley, 2000. Metallocene Catalyzed Polymers: Materials, Properties, Processing & Markets, C. M. Benedikt Ed, William Andrew Publishing, 1999). The current studies focus on developing catalysts with new structures and producing polyolefin products having new structures and high performance.

Group 4 transition metallocene complexes having special structures are also efficient catalysts for polyolefin-based elastomer polymers, such as the metallocene compound of zirconium with 2-aryl-substituted indene (Science 1995, 267, 217), the sandwich compound of titanium with substituted cyclopentadienyl-indenyl bridged by an asymmetric carbon (J. Am. Chem. Soc. 1990, 112, 2030), the sandwich compound of hafnium with cyclopentadiene and indene bridged by silicon (Macromolecules, 1995, 28, 3771, ibid, 3779), the sandwich compound of hafnium with 3-substituted indene-indene bridged by silicon (Macromolecules, 1998, 31, 1000), and the sandwich compound of hafnium with substituted indene-substituted fulvene bridged by 1,2-hexenyl (Cecilia Cobzaru, Sabine Hild, Andreas Boger, Carsten Troll, Bernhard Rieger Coordination Chemistry Review 2006, 250, 189). Thermoplastic elastomers (TPE) produced by using a catalyst of the Group 4 transition metallocene complex having such special core structures are found to have a wide range of applications and large scale industrial production.

In the development of metallocene complex catalysts, in addition to the group of numerous metallocene complexes formed of the classic bridged substituted-cyclopentadienyl (Cp′), bridged substituted-indenyl (Ind′), bridged substituted fluorenyl (Flu′), and any combinations of Cp′, Ind′ and/or Flu′ with each other (Metallocenes: Synthesis, Reactivity, Applications, A. Togni and R. L. Halterman Eds, Wiley, 1998), a number of metallocene complexes has been found in recent years in which heteroatoms such as nitrogen, phosphorus, oxygen or sulphur are introduced into the cyclopentadienyl (Cp) ring or a saturated or unsaturated ring adjacent to the Cp ring. These metallocene complexes including a heterocyclic ring either has a specific polymerization activity for olefins, or has a specific regioselectivity or stereoselectivity (Cecilia Cobzaru, Sabine Hild, Andreas Boger, Carsten Troll, Bernhard Rieger, Coordination Chemistry Reviews 2006, 250, 189; I. E. Nifant'ev, I. Laishevtsev, P. V. Ivchenko, I. A. Kashulin, S. Guidotti, F. Piemontesi, I. Camurati, L. Resconi, P. A. A. Klusener, J. J. H. Rijsemus, K. P. de Kloe, F. M. Korndorffer, Macromol. Chem. Phys. 2004, 205, 2275; C. De Rosa, F. Auriema, A. Di Capua, L. Resconi, S. Guidotti, I. Camurati, I. E. Nifant'ev, I. P. Laishevtsev, J. Am. Chem. Soc. 2004, 126, 17040).

For example, CA2204803 (DE69811211, EP983280, U.S. Pat. No. 6,051,667, WO1998050392) describes a metallocene complex containing phosphorus heteroatoms and its excellent activity for catalytic ethylene polymerization and resultant molecular weight distribution, as well as the remarkable high-temperature catalytic activity thereof. A Group-4-element metallocene complex catalytic system associated therewith may produce high molecular weight polyethylene by high temperature catalytic ethylene polymerization.

WO9822486 and EP9706297 describe a class of metallocene complexes in which the 5-member side ring, adjacent to the Cp ring, contains oxygen, and/or sulphur and/or nitrogen. Such complexes have a very high polymerization activity for propylene when bonding with methyl aluminoxane (MAO). WO0144318 describes a metallocene complex having a sulphur-containing π-ligand and a process for catalytic copolymerization of ethylene and propylene using the same; however, the resulting ethylene-propylene copolymer has little value in practical application due to its low molecular weight. WO03045964 describes a process for producing a class of zirconocene complexes having a substituted sulpho-pentalene and a substituted indene bridged by dimethylsilyl, and a process for catalytic copolymerization of ethylene and propylene using the same. With the process described in WO03045964, the zirconocene complexes have very high polymerization activity, and the resulting ethylene-propylene copolymer has a higher molecular weight, an ethylene content in the copolymer of between 4% and 13% by weight, with its material characteristics between RCP and TPE.

U.S. Pat. No. 6,756,455 describes a class of zirconocene complexes having a nitrogen-containing π-ligand, especially a zirconocene complex catalyst coordinated with a bridged indenopyrrole derivative and a bridged indenoindole derivative. Such zirconocene complexes, when used in ethylene homopolymerization, has high activity and result in high molecular weight and a double-peak molecular weight distribution under proper conditions. U.S. Pat. No. 6,683,150 discloses a Group 4 translation metallocene complex catalyst having a bridged indenoindole derivative as ligand, and further discloses various examples in which propylene polymerization is catalyzed in a broad temperature range to produce high molecular weight polypropylene. WO03089485 provides a catalyst system formed by a class of Group 4 translation metallocene complex catalyst having nitrogen-containing π-ligand in combination with methyl aluminoxane (MAO), characterized in that the catalyst system has a very low aluminum/metal ratio, high activity, and capability of producing high-molecular-weight and linear low-density polyethylene (mLLDPE), when used with a proper support.

WO9924446 describes a class of metallocene complexes formed by nitrogen heteroatom-containing π-ligands and Group 4 transition metals. Such metallocene complexes are easy to synthesize with a high yield, and are also good catalysts for olefin polymerization upon activation by methyl aluminoxane (MAO) or modified methyl aluminoxane (MMAO), to produce high-molecular-weight polyethylene and polypropylene respectively by polymerization. However, when ethylene and propylene are copolymerized by using the same catalytic system, the copolymer obtained has a lower molecular weight, and a rather blocked than random distribution of the two monomers in the copolymer. Further, as compared with classic C2-symmetric zirconocene complexes, these zirconocene complex catalysts can significantly reduce the tendency of 2,1- and 1,3-misinsertion during catalytic propylene polymerization. Although the metallocene complexes having heteroatom-containing π-ligand work exceptionally well in catalyzing ethylene and α-olefin homopolymerization, there are only very limited examples on catalytic ethylene and α-olefin homopolymerization in which the resultant materials still pertain to one of the plastic categories (WO03-045964, WO03-0489485).

### SUMMARY OF THE INVENTION

One object of the present invention is to provide a metallocene complex with a heteroatom-containing r-ligand.

Another object of the present invention is to provide a catalyst system having a metallocene complex with a heteroatom-containing π-ligand as the core component, in order to rectify the deficiency in the prior art where an isotacticity adjustable within the range of 50% to 90% cannot be achieved.

A further object of the present invention is to provide a process for synthesizing the metallocene complex with a heteroatom-containing π-ligand.

A still further object of the present invention is to provide use of the catalyst system having a metallocene complex with a heteroatom-containing π-ligand as the core component in catalytic homopolymerization or copolymerization of α-olefins.

The above objects of the present invention are achieved by the following technical solution: a metallocene complex with a heteroatom-containing π-ligand, having a chemical structure represented by formula (I) as below:

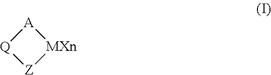

wherein M is a transition metal element from Group 3, Group 4, Group 5 and Group 6 in the periodic table, including lanthanides and actinides;

X, being the same or different from each other, is selected from hydrogen, halogen, an alkyl group R, an alkoxyl group OR, a mercapto group SR, a carboxyl group OCOR, an amino group NR₂, a phosphino group PR₂, —OR^{o}O—, and OSO₂CF₃;

n is an integer from 1 to 4 and is not zero; the charge number resulted from multiplying n by the charge number of X equals to the charge number of the central metal atom M minus 2;

Q is a divalent radical, including ═CR′₂, ═SiR′₂, ═GeR′₂, ═NR′, ═PR′, and ═BR′;

A is a π-ligand having a structure represented by chemical formula (II):

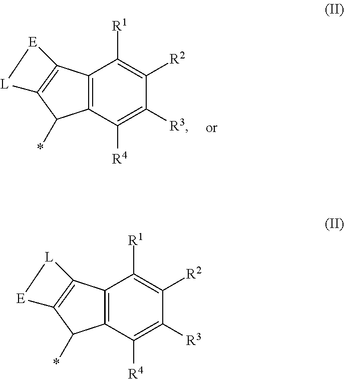

Z is a π-ligand, with Z being A or having a chemical structure represented by the following chemical formulae (IX), (X), (XI), (XII), (XIII), (XIV), or (XV):

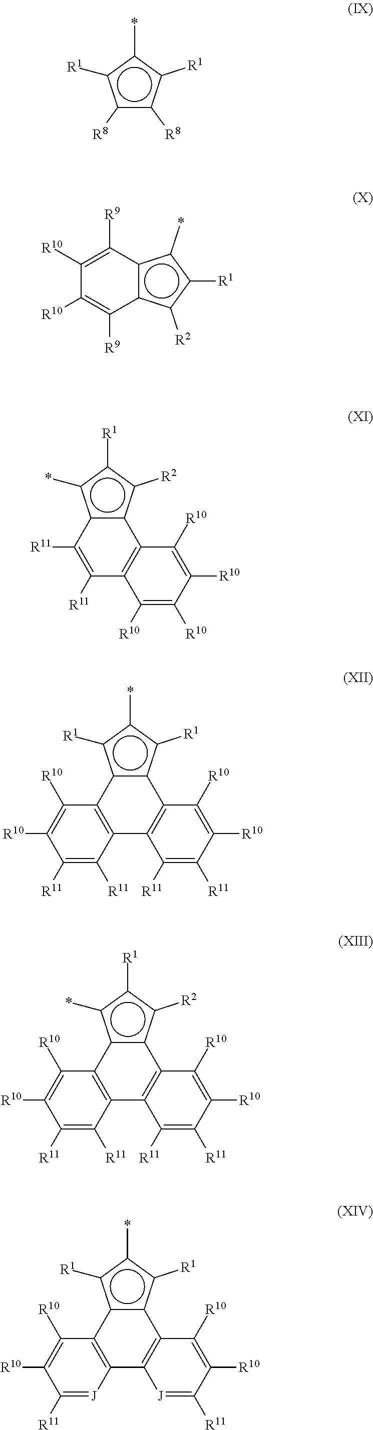

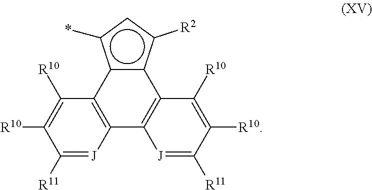

Herein, in chemical formula (I), A is a monovalent anionic π-ligand having a chemical structure represented by the chemical formula (II)-Li⁺; chemical formula (II) includes a basic structure having a cyclopentadienyl ring, while the active hydrogen in the cyclopentadienyl structure has electrophilic reactivity and can react with a nucleophilic agent in an exchange reaction to produce the compound represented by the chemical formula (II)-Li⁺, and the essential reaction thereof is shown by the reaction equation (2):

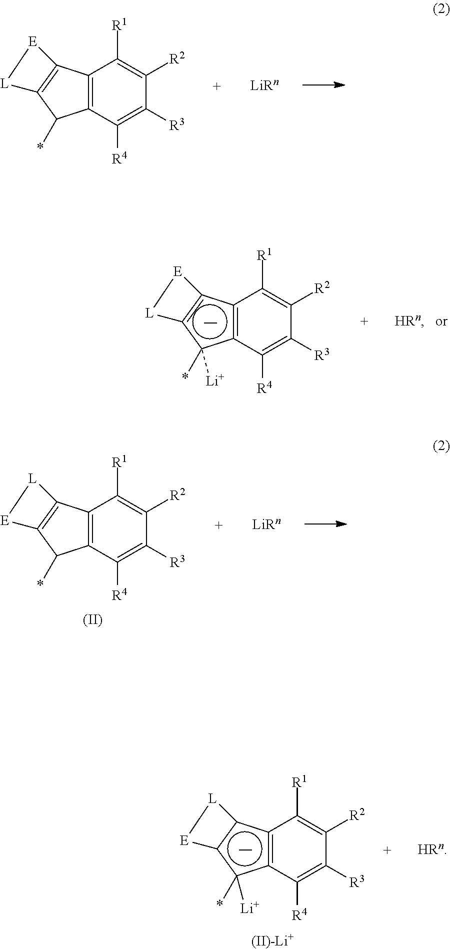

Herein, the nucleophilic agent in the reaction equation (2) is an organolithium agent RⁿLi, wherein Rⁿ is a C₁-C₆ alkyl group or a C₆-C₁₂ aryl group.

Herein, M is zirconium, hafnium, or titanium from Group 4.

Herein, R is a linear or branched, saturated or unsaturated, halogenated or non-halogenated C₁-C₂₀ alkyl group, or a C₁-C₂₀ alkyl group including a heteroatom from Groups 13 to 17 in the periodic table, or a C₃-C₂₀ cycloalkyl group, a C₆-C₃₀ aryl group, a C₇-C₃₀ alkyl-substituted aryl group, or a C₇-C₃₀ aryl-substituted alkyl group.

Herein, the heteroatom from Groups 13 to 17 in the periodic table according to the present invention is preferably boron, aluminum, silicon, germanium, sulfur, oxygen, fluorine, or chlorine.

Herein, R^{o} is a divalent radical, including a C₂-C₄₀ alkylene group, a C₆-C₃₀ arylene group, a C₇-C₄₀ alkyl-substituted arylene group, a C₇-C₄₀ aryl-substituted alkylene group; in the structure of —OR^{o}O—, the two oxygen atoms are located at any position in the radical, respectively.

Herein, in the structure of —OR^{o}O—, the combination of the positions of two oxygen atoms are ortho-α,β-positions or meta-α,γ-positions in the radical.

Herein, X is chloro, bromo, a C₁-C₂₀ lower alkyl group, or an aryl group.

Herein, R′, being the same or different, is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group.

Herein, R′ is methyl, ethyl, isopropyl, trimethylsilyl, phenyl, or benzyl.

Herein, the symbol * in chemical formula (II) connecting to a chemical bond, an atom or a radical indicates that the site linked to * forms a chemical single bond with a chemical bond, atom or radical of the same kind.

Herein, E in chemical formula (II) is a divalent radical of an element from Group 15 or 16 in the periodic table, including an oxygen radical, a sulfur radical, a selenium radical, NR″, and PR″.

Herein, R″ is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group.

Herein, R″ is a C₄-C₁₀ linear alkyl, phenyl, mono- or multi-substituted phenyl, benzyl, mono- or multi-substituted benzyl, 1-naphthyl, 2-naphthyl, 2-anthryl, 1-phenanthryl, 2-phenanthryl, or 5-phenanthryl.

Herein, R¹ is hydrogen, a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group.

Herein, R¹ is hydrogen, methyl, ethyl, isopropyl, t-butyl, phenyl, benzyl, 2-furyl, or 2-thienyl.

Herein, R² and R³ are independently hydrogen, fluoro, or R, wherein R is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group.

Herein, R⁴ is hydrogen, a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group.

Herein, R⁴ is H, methyl, trifluoromethyl, isopropyl, t-butyl, phenyl, p-tert-butylphenyl, p-trimethylsilylphenyl, p-trifluoromethylphenyl, 3,5-dichloro-4-trimethylsilylphenyl, or 2-naphthyl.

Herein, L is a divalent radical and has the following structures represented by chemical formulae (III), (IV), (V), (VI), (VII) or (VIII):

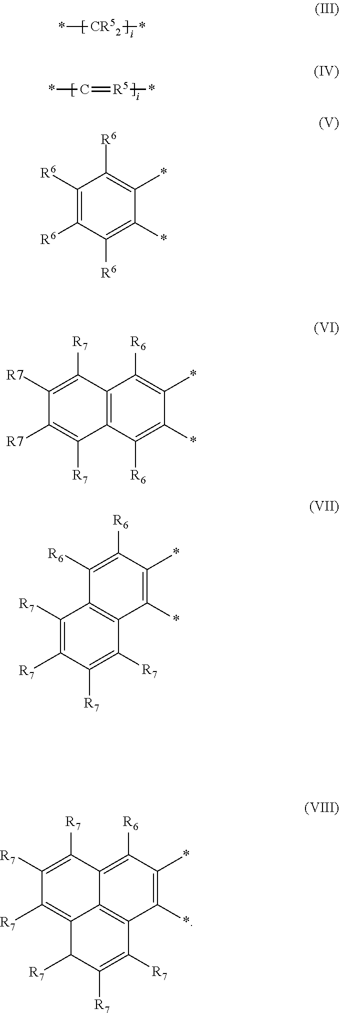

Here, the symbol * connecting to a chemical bond, an atom, or a radical indicates that the site linked to * forms a chemical single bond with a chemical bond, atom or radical of the same kind.

Herein, in formulae (III) and (IV), i is an integer and i is not zero.

Herein, in formulae (III) and (IV), i is 2.

Herein, R⁵, being the same or different, is a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group.

Herein, R⁵ is hydrogen, fluoro, or methyl.

Herein, R⁶ and R⁷ in chemical formulae (V), (VI), (VII) and (VIII) are independently hydrogen, fluoro, or R, wherein R is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group.

Here, in chemical formulae (IX), (X), (XI), (XII), (XIII), (XIV) and (XV), the symbol * connecting to a chemical bond, an atom or a radical indicates that the site linked to * forms a chemical single bond with a chemical bond, atom or radical of the same kind.

Herein, in chemical formulae (IX), (X), (XI), (XII), (XIII), (XIV) and (XV), R¹ is hydrogen, a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group; in chemical formulae (X), (XI), (XIII) and (XV), R² is hydrogen, fluoro, or R, wherein R is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group.

Herein, in chemical formulae (IX), (X), (XI), (XII), (XIII) and (XIV), R¹ is hydrogen, methyl, ethyl, isopropyl, t-butyl, phenyl, benzyl, 2-furyl, or 2-thienyl.

Herein, R⁸, being the same or different, is a C₁-C₄₀ alkyl group which is saturated or unsaturated, halogenated or non-halogenated, or contains a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group.

Herein, R⁸ is methyl, ethyl, isopropyl, t-butyl, or phenyl.

Herein, R⁹, being the same or different, is a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group.

Herein, R⁹ is a linear or branched, saturated or unsaturated, partially or wholly halogenated, linear or cyclic C₁-C₂₀ carbon radical.

Herein, R¹⁰, being the same or different, is hydrogen, a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group.

Herein, R¹⁰ is hydrogen, fluoro, chloro, methyl, ethyl, or phenyl.

Herein, R¹¹, being the same or different, is hydrogen, fluoro, chloro, bromo, OR, SR, OCOR, NR₂, or PR₂, wherein R is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group; or R¹¹ is a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group.

Herein, J is an element of Group 13 or 15 in the periodic table, including boron, aluminum, gallium, nitrogen, phosphorus and, arsenic.

Herein, J is nitrogen or phosphorus.

Provided is a catalyst system of a metallocene complex with a heteroatom-containing π-ligand comprising a compound represented by chemical formula (Ia), wherein the compound represented by chemical formula (Ia) is prepared from the metallocene complex (I) according to claim 1 via an activation reaction as shown by the reaction equation (1):

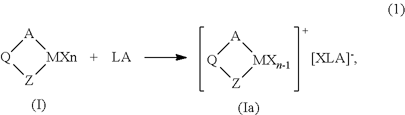

wherein, LA is a Lewis acid substance.

Herein, LA is a polymethylaluminoxane or modified polymethylaluminoxane having simultaneously chain-, cyclic- and cage-like structures in equilibrium in a solution.

Herein, the activation reaction is completed in a homogeneous liquid medium comprising a saturated-alkane liquid medium and an aromatic liquid medium, wherein the saturated alkane includes pentane and isomers thereof, hexane and isomers thereof, heptane and isomers thereof, as well as octanes and isomers thereof, and the aromatic liquid medium includes benzene, toluene, xylene and isomers thereof, trimethylbenzene and isomers thereof, chlorobenzene, dichlorobenzene and isomers thereof, fluorobenzene, difluorobenzene and isomers thereof, as well as polyfluorobenzene and isomers thereof.

Herein, the homogeneous liquid medium used in the activation reaction is a mixed liquid medium having two or more components, wherein the mixed liquid medium refers to a mixture of the saturated alkane and the aromatic hydrocarbon mixed in such a volume percentage ratio that the volume percentage of one of the liquid medium components is not less than 5%.

Herein, the activation reaction is completed at a temperature in the range of −100° C. to +250° C., with the yield of the reaction product (la) being 95% or more.

Herein, the reaction temperature of the activation reaction is between −75° C. and 150° C.

A process for synthesizing the metallocene complex with a heteroatom-containing π-ligand according to the present invention is provided, which process is represented by the following reaction equation (3) of the heteroatom-containing π-ligand:

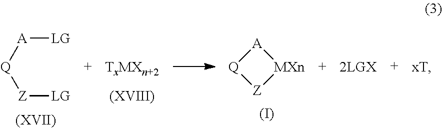

wherein, T, being the same or different from each other, is a monodentate or bidentate neutral ligand;

LG is a leaving group, same as or different from each other, being hydrogen, an alkali metal element, or an organic radical of a Group 14 heavy element.

Herein, the monodentate ligand includes ethers (RORs), thioethers (RSRs), tertiary amines (NR₃), tertiary phosphines (PR₃), cyclic ethers, cyclic thioethers, ketones, substituted cyclic ketones, substituted pyridines, substituted pyrroles, substituted piperazines, esters, lactones, amides, and lactams, wherein R is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group.

Herein, the bidentate ligand includes ortho-diethers, α,ω̅-diethers, ortho-diamines, α,ω̅-diamines, ortho-disulfides, α,ω̅-disulfides, ortho-bisphosphines, and α,ω̅-bisphosphines.

Herein, x is 0 or an integer of 1, 2 or 3.

Herein, the alkali metal element includes lithium, sodium, and potassium; the organic radical of a Group 14 heavy element includes SiR₃, GeR₃, SnR₃, PdR₃, ZnR, BaR, MgR, and CaR, wherein R is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group.

Herein, in the synthesis process, the reaction medium is a saturated C₅-C₁₅ alkane, cycloalkane or a mixture of two or more thereof.

Herein, in the synthesis process, the reaction medium is hexane, heptane, octane, toluene, or xylene.

Herein, the reaction temperature is in the range of −100° C. to +300° C.

Herein, the reaction temperature is in range of −75° C. to +250° C.

Herein, the reaction temperature is in the range of −50° C. to +150° C.

Provided is the use of the catalyst system of a metallocene complex with a heteroatom-containing π-ligand in catalytic polymerization or copolymerization of α-olefins under the conditions of bulk slurry or solvent slurry polymerization.

The advantageous effect of the present invention: a catalyst of a quasi-C2 structure is synthesized, and a polyolefin material having an isotacticity that can be regulated within the range of 50% to 90% is prepared.

### DETAILED DESCRIPTION OF THE INVENTION

The technical solutions of the present invention will now be described in details with reference to the following examples, which are encompassed in, but not limiting the protection scope of the present invention.

1. Metallocene Complexes with a Heteroatom-Containing π-Ligand

The novel metallocene complexes according to the present invention are a class of sandwich complexes formed by a bridged dicyclopentadiene derivative with a transition metal from Group 3, Group 4, or Group 5, or a lanthanide or an actinide, and having a quasi-C2 symmetrical structure (the bridged dicyclopentadiene derivative structure has C1 symmetry, but the regioselectivity and stereoselectivity thereof are also characteristic to a C2 symmetrical structure, and thus it is defined as quasi-C2 symmetrical structure). In the complex, at least one cyclopentadiene derivative contains a heteroatom, for example, a non-metallic element such as O, S, Se, N, P, As, Si, and B.

The novel metallocene complex with a heteroatom-containing π-ligand according to the present invention has a common chemical structure as shown by a general chemical formula (I) below:

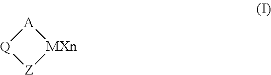

In chemical formula (I),

M is a transition metal element from Group 3, Group 4, Group 5 and Group 6 in the periodic table, including lanthanides and actinides; M is preferably a metal element from Group 3, Group 4, or lanthanides, and is most preferably zirconium, hafnium or titanium from Group 4.

X, being the same or different from each other, is selected from hydrogen, halogen, an alkyl goup R, an alkoxyl goup OR, a mercapto group SR, a carboxyl group OCOR, an amino group NR₂, a phosphino group PR, —OR^{o}O— and OSO₂CF₃, wherein:

R is a linear or branched, saturated or unsaturated, halogenated or non-halogenated C₁-C₂₀ alkyl group, optionally including a heteroatom from Groups 13 to 17 in the periodic table, or a C₃-C₂₀ cycloalkyl group, a C₆-C₃₀ aryl group, a C₇-C₃₀ alkyl-substituted aryl group, or a C₇-C₃₀ aryl-substituted alkyl group. Examples of the C₁-C₂₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₂₀ cycloalkyl group include, but are not limited to, cyclopropyl, cyclobutyl, cyclopentyl, cyclohexyl, cyclooctyl, 1-adamantanyl, and the like. Examples of the C₆-C₃₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the C₇-C₃₀ alkyl-substituted aryl group include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the C₇-C₃₀ aryl-substituted alkyl group include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylbenzyl, 3,5-bis-trifluoromethylbenzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R^{o} is a divalent radical, such as a C₂-C₄₀ alkylene group, a C₆-C₃₀ arylene group, a C₇-C₄₀ alkyl-substituted arylene group, a C₇-C₄₀ aryl-substituted alkylene group; in the structure of —OR^{o}O—, the two oxygen atoms may be at any position of the radical, respectively; preferably, the combination of the positions of the two oxygen atoms are the ortho-positions (α,β-positions) and the meta-positions (α,γ-positions) in the radical.

Among the infinite combinations, X is preferably halogen (chloro, bromo), a lower alkyl group, or an aryl group such as, but not limited to, methyl, phenyl, or benzyl.

n is an integer from 1 to 4 and is not zero; the charge number resulted from multiplying n by the charge number of X equals to the charge number of the central metal atom M minus 2.

Q is a divalent radical, such as ═CR′₂, ═SiR′₂, ═GeR′₂, ═NR′, ═PR′, and ═BR′, wherein:

R′, being the same or different, is a linear or branched, saturated or unsaturated, halogenated or non-halogenated C₁-C₂₀ alkyl group, optionally including a heteroatom from Groups 13 to 17 in the periodic table such as boron, aluminum, silicon, germanium, sulfur, oxygen, fluorine, and chlorine, or a C₃-C₂₀ cycloalkyl group, a C₆-C₃₀ aryl group, a C₇-C₃₀ alkyl-substituted aryl group, or a C₇-C₃₀ aryl-substituted alkyl group. Examples of the C₁-C₂₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₂₀ cycloalkyl group include, but are not limited to, cyclopropyl, cyclobutyl, cyclopentyl, cyclohexyl, cyclooctyl, 1-adamantanyl, and the like. Examples of the C₆-C₃₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the C₇-C₃₀ alkyl-substituted aryl group include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the C₇-C₃₀ aryl-substituted alkyl group include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethyl-benzyl, 3,5-bis-trifluoromethyl-benzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

Among the infinite combinations, R′ is preferably methyl, ethyl, isopropyl, trimethylsilyl, phenyl, or benzyl.

A is a π-ligand having a general structure represented by chemical formula (II):

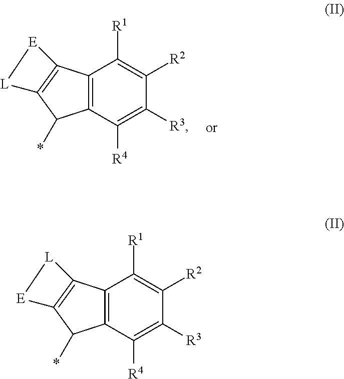

In the general chemical formula (II), the symbol * represents that, whether linked to a chemical bond, an atom, or a radical, the site can form a chemical single bond with a chemical bond, atom or radical of the same kind; hereinafter, all the symbol * have the same meaning.

E is a divalent radical having an element of Group 15 or 16 in the periodic table, such as an oxygen radical, a sulfur radical, a selenium radical, NR″ and PR″, wherein:

R″ is a linear or branched, saturated or unsaturated, halogenated or non-halogenated C₁-C₂₀ alkyl group, optionally including a heteroatom from Groups 13 to 17 in the periodic table such as boron, aluminum, silicon, germanium, sulfur, oxygen, fluorine and chlorine, or a C₃-C₂₀ cycloalkyl group, a C₆-C₃₀ aryl group, a C₇-C₃₀ alkyl-substituted aryl group, or a C₇-C₃₀ aryl-substituted alkyl group. Examples of the C₁-C₂₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₂₀ cycloalkyl group include, but are not limited to, cyclopropyl, cyclobutyl, cyclopentyl, cyclohexyl, cyclooctyl, 1-adamantanyl, and the like. Examples of the C₆-C₃₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the C₇-C₃₀ alkyl-substituted aryl group include, but are not limited to, 2-methylphenyl, 2,6-dimethylphenyl, 2-fluoro-3-methylphenyl, 2-fluoro-4-methylphenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methylphenyl, 3,5-difluoro-4-ethylphenyl, 3,5-difluoro-4-isopropylphenyl, 3,5-difluoro-4-tert-butyl phenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the C₇-C₃₀ aryl-substituted alkyl group include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethyl-benzyl, 3,5-bis-trifluoromethyl-benzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

Among the infinite combinations, R″ is preferably a C₄-C₁₀ linear alkyl group, phenyl, mono- or multi-substituted phenyl, benzyl, mono- or multi-substituted benzyl, 1-naphthyl, 2-naphthyl, 1-anthryl, 1-phenanthryl, 2-phenanthryl, or 5-phenanthryl; hereinafter, all the R″ have the same meaning.

E is preferably an element such as sulfur or oxygen, NR″, and PR″, in which R″ is defined as above.

R¹ is any one of the following: hydrogen, a saturated or unsaturated, halogenated or non-halogenated C₁-C₄₀ alkyl group, optionally including a heteroatom from Groups 13 to 17 in the periodic table such as boron, aluminum, silicon, germanium, sulfur, oxygen, fluorine, and chlorine, or a C₃-C₄₀ cycloalkyl group, a C₆-C₄₀ aryl group, a C₇-C₄₀ alkyl-substituted aryl group, or a C₇-C₄₀ aryl-substituted alkyl group. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the C₇-C₄₀ alkyl-substituted aryl group include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the C₇-C₄₀ aryl-substituted alkyl group include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethyl-benzyl, 3,5-bis-trifluoromethyl-benzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R¹ is preferably hydrogen, methyl, ethyl, isopropyl, t-butyl, phenyl, benzyl, 2-furyl, or 2-thienyl; hereinafter, all the R¹ have the same meaning.

R² and R³ are hydrogen, fluoro, or R. R is defined as above. R² and R³ are preferably hydrogen. Hereinafter, all of the R² and R³ have the same meaning.

R⁴ is any one of the following: hydrogen, a saturated or unsaturated, halogenated or non-halogenated C₁-C₄₀ alkyl group, optionally including a heteroatom from Groups 13 to 17 in the periodic table such as boron, aluminum, silicon, germanium, sulfur, oxygen, fluorine, and chlorine, or a C₃-C₄₀ cycloalkyl group, a C₆-C₄₀ aryl group, a C₇-C₄₀ alkyl-substituted aryl group, or a C₇-C₄₀ aryl-substituted alkyl group. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C1-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the C₇-C₄₀ alkyl-substituted aryl group include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the C₇-C₄₀ aryl-substituted alkyl group include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilyl-benzyl, 3,5-bis-trifluoromethyl-benzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R⁴ is preferably H, methyl, trifluoromethyl, isopropyl, t-butyl, phenyl, p-tert-butylphenyl, p-trimethylsilylphenyl, p-trifluoromethylphenyl, 3,5-dichloro-4-trimethylsilylphenyl, or 2-naphthyl; hereinafter, all the R⁴ have the same meaning.

L is a divalent radical with any one of the following structures represented by general chemical formulae (III), (IV), (V), (VI), (VII) or (VIII):

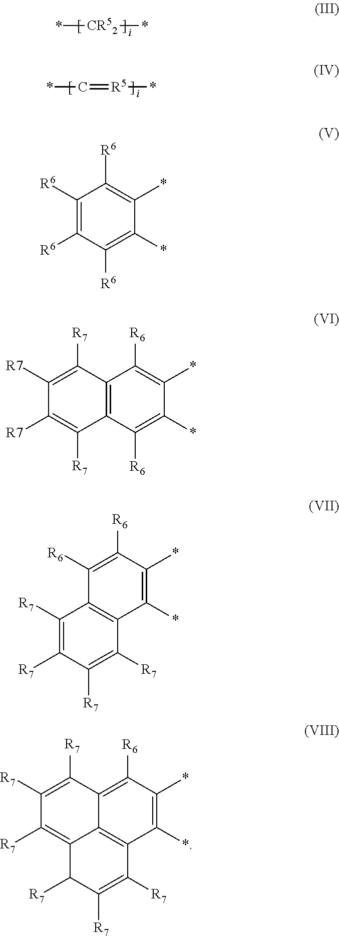

The symbol * indicates that, whether connecting to a chemical bond, an atom, or a radical, the site can form a chemical single bond with a chemical bond, atom or radical of the same kind; hereinafter, all the symbol * have the same meaning.

In general chemical formulae (III) and (IV):

i is an integer and is not zero, and is preferably 2.

R⁵, being the same or different, is any one of the following: a saturated or unsaturated, halogenated or non-halogenated C₁-C₄₀ alkyl group, optionally including a heteroatom from Groups 13 to 17 in the periodic table such as boron, aluminum, silicon, germanium, sulfur, oxygen, fluorine and chlorine, or a C₃-C₄₀ cycloalkyl group, a C₆-C₄₀ aryl group, a C₇-C₄₀ alkyl-substituted aryl group, or a C₇-C₄₀ aryl-substituted alkyl group. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the C₇-C₄₀ alkyl-substituted aryl group include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the C₇-C₄₀ aryl-substituted alkyl group include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilyl-benzyl, 3,5-bis-trifluoromethyl-benzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R⁵ is preferably hydrogen, fluoro, or methyl; hereinafter, all the R⁵ have the same meaning.

In general chemical formulae (V), (VI), (VII) and (VIII), R⁶ and R⁷ are equivalent to R³ as defined above. R⁶ and R⁷ are preferably hydrogen or fluorine. Hereinafter, all of the R⁶ and R⁷ have the same meaning.

In general chemical formula (I):

Z is a π-ligand, with Z being A as defined above or having a chemical structure represented by the following general chemical formulae (IX), (X), (XI), (XII), (XIII), (XIV) or (XV):

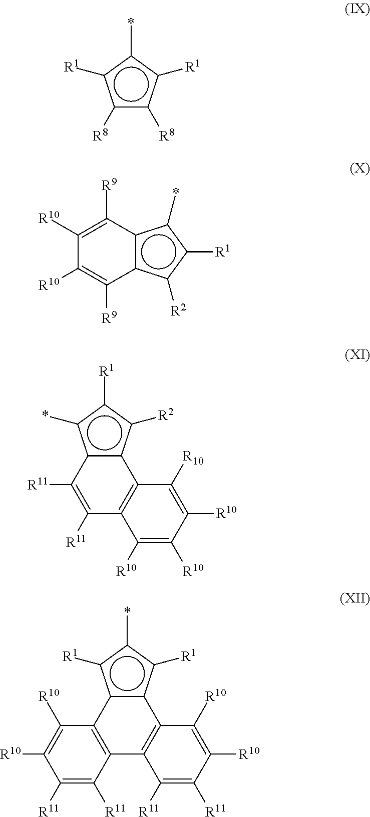

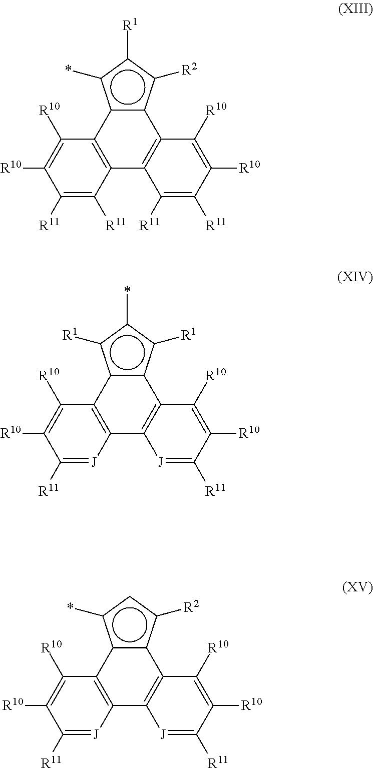

The symbol * indicates that, whether to a chemical bond, an atom, or a radical, the site can form a chemical single bond with a chemical bond, atom or radical of the same kind; hereinafter, all the symbol * have the same meaning.

In general chemical formulae (IX), (X), (XI), (XII), (XIII), (XIV) and (XV):

R¹ is as defined above.

R¹ is preferably hydrogen, methyl, ethyl, isopropyl, t-butyl, phenyl, benzyl, 2-furyl, or 2-thienyl.

R² is hydrogen, fluoro, or R as defined above. R² is preferably hydrogen.

R⁸, being the same or different, is any one of the following: a saturated or unsaturated, halogenated or non-halogenated C₁-C₄₀ alkyl group, optionally including a heteroatom from Groups 13 to 17 in the periodic table, or a C₃-C₄₀ cycloalkyl group, a C₆-C₄₀ aryl group, a C₇-C₄₀ alkyl-substituted aryl group, or a C₇-C₄₀ aryl-substituted alkyl group. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the C₇-C₄₀ alkyl-substituted aryl group include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethyl phenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the C₇-C₄₀ aryl-substituted alkyl group include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilyl-benzyl, 3,5-bis-trifluoromethyl-benzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R⁸ is preferably methyl, ethyl, isopropyl, t-butyl, or phenyl; hereinafter, all the R⁸ have the same meaning.

R⁹, being the same or different, is any one of the following: a saturated or unsaturated, halogenated or non-halogenated C₁-C₄₀ alkyl group, optionally including a heteroatom from Groups 13 to 17 in the periodic table, or a C₃-C₄₀ cycloalkyl group, a C₆-C₄₀ aryl group, a C₇-C₄₀ alkyl-substituted aryl group, or a C₇-C₄₀ aryl-substituted alkyl group. Examples of the C1-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the C₇-C₄₀ alkyl-substituted aryl group include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the C₇-C₄₀ aryl-substituted alkyl group include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilyl-benzyl, 3,5-bis-trifluoromethyl-benzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R⁹ is preferably a linear or branched, saturated or unsaturated, partially or wholly halogenated, linear or cyclic C₁-C₂₀ carbon radical; hereinafter, all the R's have the same meaning.

R¹⁰, being the same or different, is any one of the following: hydrogen, a C₁-C₄₀ alkyl group which is saturated or unsaturated, halogenated or non-halogenated, optionally including a heteroatom from Groups 13 to 17 in the periodic table such as boron, aluminum, silicon, germanium, sulfur, oxygen, fluorine and chlorine, or a C₃-C₄₀ cycloalkyl group, a C₆-C₄₀ aryl group, a C₇-C₄₀ alkyl-substituted aryl group, or a C₇-C₄₀ aryl-substituted alkyl group. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the C₇-C₄₀ alkyl-substituted aryl group include, but are not limited to, 2-methylphenyl, 2,6-dimethylphenyl, 2-fluoro-3-methylphenyl, 2-fluoro-4-methylphenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the C₇-C₄₀ aryl-substituted alkyl group include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilyl-benzyl, 3,5-bis-trifluoromethyl-benzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R¹⁰ is preferably hydrogen, fluoro, chloro, methyl, ethyl, or phenyl; hereinafter, all the R¹⁰ have the same meaning.

R¹¹, being the same or different, and is any one of the following: hydrogen, fluoro, chloro, bromo, OR, SR, OCOR, NR₂, or PR₂, in which R is as defined above. Alternatively, R¹¹, being the same or different, is any one of the following: a saturated or unsaturated, halogenated or non-halogenated C₁-C₄₀ alkyl group, optionally including a heteroatom from Groups 13 to 17 in the periodic table such as boron, aluminum, silicon, germanium, sulfur, oxygen, fluorine and chlorine, or a C₃-C₄₀ cycloalkyl group, a C₆-C₄₀ aryl group, a C₇-C₄₀ alkyl-substituted aryl group, or a C₇-C₄₀ aryl-substituted alkyl group. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the C₇-C₄₀ alkyl-substituted aryl group include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the C₇-C₄₀ aryl-substituted alkyl group include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilyl-benzyl, 3,5-bis-trifluoromethyl-benzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R¹¹ is preferably hydrogen, fluoro, chloro, OCOR, OR, SR, NR₂, or PR₂; hereinafter, all the R¹¹ have the same meaning.

J is an element of Group 13 or 15 in the periodic table, such as boron, aluminum, gallium, nitrogen, phosphorus, and arsenic.

J is preferably nitrogen or phosphorus; hereinafter, all the J have the same meaning.

In general chemical formula (I), A is a monovalent anionic π-ligand. Also, the precursor of A is a neutral stable organic compound having a chemical structure represented by general formula (II):

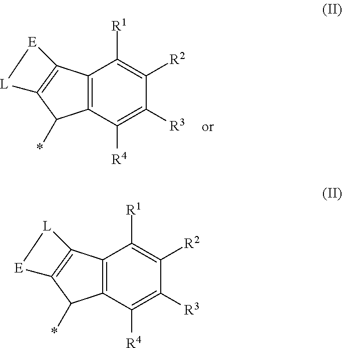

In the general chemical formula (II), R¹, R², R³, R⁴, L and E are as defined above. Further, the general chemical formula (II) comprises a basic cyclopentadienyl ring structure. The cyclopentadienyl structure has an active hydrogen which has specific electrophilic reactivity and may react with a nucleophilic agent such as a Grignard agent or an organolithium agent in an exchange reaction, and the basic reaction is shown by the general reaction equation (2):

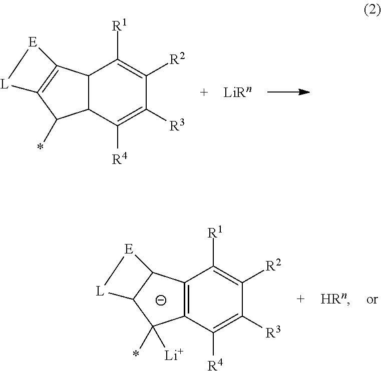

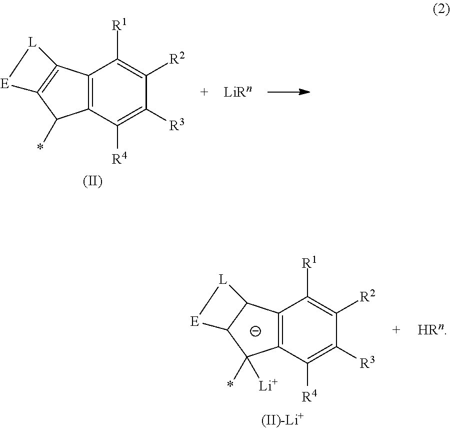

In the general reaction equation (2), the nucleophilic agent is exemplified as an organolithium agent RⁿLi, but is not limited to the organolithium agent in practice. Rⁿ is a C1-C₆ alkyl group or a C₆-C₁₂ aryl group.

The synthesis of the metallocene complexes according to the present invention comprises a multi-step organic synthesis of cyclopentadiene derivatives, highly efficient synthesis of bridged ligands, and highly efficient synthesis of quasi-C2 symmetric metallocene complexes with high yields.

The synthesis process for the novel metallocene complexes with heteroatom-containing rt-lignds, represented by general formula (I), may be represented by the following general reaction equation (3):

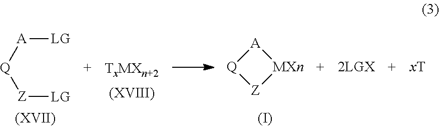

In the general reaction equation (3), the general chemical formula (I) is as defined above.

In the general chemical formula (XVIII), M, X and n are as defined above.

T, being the same as or different from each other, is a monodentate or bidentate neutral ligand.

Examples of the monodentate ligand include ethers (ROR), thioethers (RSR), tertiary amines (NR₃), tertiary phosphines (PR₃), cyclic ethers (e.g., substituted tetrahydrofuran, substituted furan, substituted dioxane, etc.), cyclic thioethers, ketones, substituted cyclic ketones, substituted pyridines, substituted pyrroles, substituted piperidines, esters, lactones, amides, lactams, and the like, wherein R is as defined above.

Examples of the bidentate ligand include ortho-diethers, α,ω̅-diethers, ortho-diamines, α,ω̅-diamines, ortho-disulfides, α,ω̅-disulfides, ortho-bisphosphines, α,ω̅-bisphosphines, and the like.

Among the infinite combinations, T is preferably cyclic ethers as a neutral monodentate ligand or ortho-diamines as a bidentate ligand.

x is 0 or an integer of 1, 2 or 3.

In chemical formula (XVII), Q, A and Z are as defined above.

LG is a leaving group, same as or different from each other, which may be, but not limited to, hydrogen, an alkali metal element such as lithium, sodium or potassium, or an organic radical of heavy elements of Group 14, such as SiR₃, GeR₃, SnR₃, PdR₃ and ZnR, BaR, MgR, CaR, and the like, wherein R is as defined above.

The above general reaction equation (3) may represent various types of metathesis reactions. The most ordinary example is a metathesis reaction between an anionic bidentate ligand in which LG is an alkali metal cation and a metal halide, to produce the desired metallocene complex (I) by eliminating an alkali metal halide (LGX in the general reaction equation (3), with LG being lithium, for example, and X being chloride, for example). This ordinary reaction type is the synthetic approach most commonly used for the synthesis of metallocene complexes, also applicable to the synthesis of the novel metallocene complexes with heteroatom-containing Ti-ligand according to the present invention. When LG in the general chemical formula (XVII) is an alkali metal cation (Li⁺, Na⁺, K⁺) and X in the general formula (XVIII) is halide (Cl⁻, Br⁻, I⁻), such metathesis reactions are usually thermodynamically driven. Thus, the ratio between the isomers in the product is close to a statistical average value.

In addition to the general synthetic process as described above, the novel metallocene complexes with heteroatom-containing π-ligand according to the present invention may be prepared by a variety of other methods.

For example, when the leaving group LG in general chemical formula (XVII) is hydrogen, X in the general formula (XVIII) may be selected from R or NR₂, wherein R is as defined above. In such reactions, the neutral ligand (in which LG is H) reacts with an alkyl compound of a transition metal from Groups 3 to 6 or an organic amino compound of a transition metal from Groups 3 to 6 in a metathesis reaction, in a suitable solvent and within a proper temperature range, so as to eliminate a neutral alkane or a neutral secondary amine and produce the desired metallocene complex (I) with π-ligand at the same time. Here, the reaction of an organic amine having a transition metal from Group 4 with a bridged neutral π-ligand in a suitable organic solvent and within a proper temperature range to produce a metallocene complex of a transition metal from Group 4 has been thoroughly implemented in practice (J N Christopher; G. M. Diamond; R. F. Jordan; J. L. Petersen, Organometallics 1996, 15, 4038. G. M. Diamond; R. F. Jordan; J. L. Petersen, JACS, 1996, 118, 8024).

Suitable solvents are selected from, but not limited to, saturated C₅-C₁₅ alkanes and cycloalkanes such as pentane, cyclopentane, n-hexane, cyclohexane, heptane, cycloheptane, octane, cyclooctane, n-dodecane and the like; or aromatic hydrocarbons and substituted aromatic hydrocarbons, such as benzene, toluene, o-xylene, m-xylene, p-xylene, trimethylbenzene, chlorobenzene, o-dichlorobenzene, m-dichlorobenzene, p-dichlorobenzene, and trichlorobenzene. Among them, hexane, heptane, octane, toluene or xylene is preferred. A mixture of two or more of the above-mentioned organic solvents may be also used as the reaction medium. An appropriate reaction temperature range is −100° C. to +300° C. A more appropriate reaction temperature range is generally −75° C. to +250° C. The most appropriate reaction temperature range is −50° C. to +150° C.

Additionally, for example, when LG in the general chemical formula (XVII) is an organic radical of a heavy element of Group 14 such as SiR₃, GeR₃, SnR₃, PdR₃, ZnR, BaR, MgR, CaR and the like, X in the general formula (XVIII) may be selected from halogen (Cl, Br, I), an alkoxy group OR, a mercapto group SR, a carboxy group OCOR, OCOCF₃, and OSO₂CF₃, wherein R is as defined above. In such reactions, a neutral ligand (in which the organic radical of a heavy element of Group 14 is, for example, SiR₃, GeR₃, SnR₃, PdR₃, ZnR, BaR, MgR, CaR and the like) reacts with a compound represented by general chemical formula (XVIII) in a metathesis reaction, in an appropriate solvent and within an appropriate temperature range, and neutral organic molecules are eliminated. In particular, for example, when LG in the general chemical formula (XVII) is SnR₃, and X in the general formula (XVIII) is Cl, in the above metathesis reaction, a neutral CISnR₃ molecule is eliminated. When LG in the general chemical formula (XVII) is GeR₃, and X in the general chemical formula (XVIII) is OR, the above metathesis reaction can be carried out in an appropriate solvent and within an appropriate temperature range so as to eliminate a neutral ROGeR₃ molecule and produce the desired metallocene complex molecules with π-ligand according to the general chemical formula (I). The preparation of metallocene complexes of a transition metal from Group 4 using such metathesis reactions has also been reported. For example, U.S. Pat. No. 6,657,027 (WO02076999, DE10114345, EP1373284) describes a reaction of Group 4 transition metal halide with Cp-LG (Cp is a substituted cyclopentadiene, substituted indene and the like, and LG is SnR₃) to prepare a variety of so-called donor-acceptor bridged metallocene complexes of a transition metal from Group 4.

Suitable solvents are selected from saturated C₅-C₁₅ alkanes, cycloalkanes and aromatic hydrocarbons. The alkanes and cycloalkanes are, for example, pentane, cyclopentane, n-hexane, cyclohexane, heptane, cycloheptane, octane, cyclooctane, n-dodecane, and partially or wholly fluorinated alkanes and cycloalkanes as described above; the aromatic hydrocarbons and partially or wholly fluorinated aromatic hydrocarbons are for example, but not limited to, benzene, toluene, trifluoromethylbenzene, o-xylene, m-xylene, p-xylene, trimethylbenzene, fluorobenzene, o-difluorobenzene, m-difluorobenzene, p-difluorobenzene, trifluorobenzene, perfluorobenzene, and the like. Among them, hexane, heptane, octane, toluene, and xylene are preferred. A mixture of two or more of the above-mentioned organic solvents may also be used as the reaction medium. An appropriate reaction temperature range is −100° C. to +300° C. A more appropriate reaction temperature range is generally −75° C. to +250° C. The most appropriate reaction temperature range is −50° C. to +150° C.

In the metathesis reaction represented by the general reaction equation (3), when the general formula (XVII) is neutral, that is, LG is hydrogen, and X in the general formula (XVIII) is an alkyl R or amino NR₂; or in the general chemical formula (XVII), LG is an organic radical such as SiR₃, GeR₃, SnR₃, PdR₃, ZnR, BaR, MgR, CaR and the like, and X in the general formula (XVIII) is halogen (Cl, Br, I), alkoxy OR, alkylthio SR, carboxy OCOR, OCOCF₃, or OSO₂CF₃ (R is as defined above), the thermodynamics of this metathesis reaction can be regulated by adjusting conditions such as the polarity of the solvent and the reaction temperature, to regulate the selectivity to the resulting product in favor of the formation of isomers with high thermodynamic stability. For example, when A in general chemical formula (I) is Z, the general chemical formula (I) represents a type of the most common metallocene complex with quasi-C2 symmetrical structures. Compounds having quasi-C2 symmetrical structures usually have two isomers, namely, racemic isomers and mesoisomers. When A in general chemical formula (I) is not Z, it represents metallocene complexes having a structure of C1 symmetry by definition. The present invention relates to metallocene complexes having quasi-C2 symmetric stuctures (also referred to as “pseudo-C2 symmetric metallocenes”), which has quasi-C2 symmetric characteristics due to the steric environment surrounding its catalytically active center. Compounds having quasi-C2 symmetrical structures also have two stereoisomers generally, that is, cis- (namly syn, the metallocene complexes of the present invention having R¹ substituents on the same side of the molecule) and trans- (namely anti, the metallocene complexes of the present invention having R¹ substituents on opposite sides of the molecule) isomers. Among the isomers of C2 symmetric and quasi-C2 symmetric metallocene complexes, the racemic (Rac) and trans-isomers (Anti) generally have a higher thermodynamic stability than the meso- (Meso) and cis-isomers (Syn). The metathesis reaction between the neutral ligand of the general chemical formula (XVII) and TxMXn represented by the general formula (XVIII) in the general reaction equation (3) is characteristic in its thermodynamic controllability, and the rate of generating the isomers (racemic (Rac), and trans- (anti)) having a higher thermodynamic stability can be enhanced to the utmost extent by adjusting the reaction conditions such as the solvent polarity, the reaction temperature, the concentration of the substrate for reaction and the like. The feature of the reaction of such a specific thermodynamic selectivity for reaction has been successfully utilized in the preparation of the so-called donor-acceptor bridged Group 4 transition metallocene complexes (U.S. Pat. No. 6,657,027, WO0207699, DE10114345, EP1373284) and in the preparation of the Group 4 transition metallocene-organic amine complexes by amine elimination (J. N. Christopher; G. M. Diamond, R. F. Jordan; J. L. Petersen, Organometallics 1996, 15, 4038. G. M. Diamond; R. F. Jordan; J. L. Petersen; JACS, 1996, 118, 8024).

There is such a variety of the central metal atom M (metals from the Group 3 to Group 6, lanthanides and actinides), the rt-dentates A and Z, the bridged group Q between rt-dentates A and Z, and the ligand X, as well as the various substituents R, R^{o}, R′, R″, and R¹ to R¹¹ on Q, X, A and Z that the combinations thereof result in a population of a great number of derivatives. Thus, the novel metallocene complexes with heteroatom-containing π-ligand represented by the general chemical formula (I) encompass a great number of novel metallocene complexes having special chemical structures and reactivition and catalytic characteristics which undoubtedly have excellent value in development of fundational theoretical researches and in practical applications (e.g, in the applications of asymmetric organic synthesis chemistry, homogeneous or heterogeneous catalytic polymerization chemistry of olefins and α-olefins). The synthetic scheme of the quasi-C2 symmetric Group 4 transition metallocene complex illustrated by the following synthetic scheme of a dimethylsilyl-bridged metallocene complex (shown by the following reaction equation) shows a typical approach for the metallocene catalyst for olefin polymerization according to the present invention, but this does not mean that all the metallocene complexes in the Examples of the present invention may be synthetized by such a typical approach.

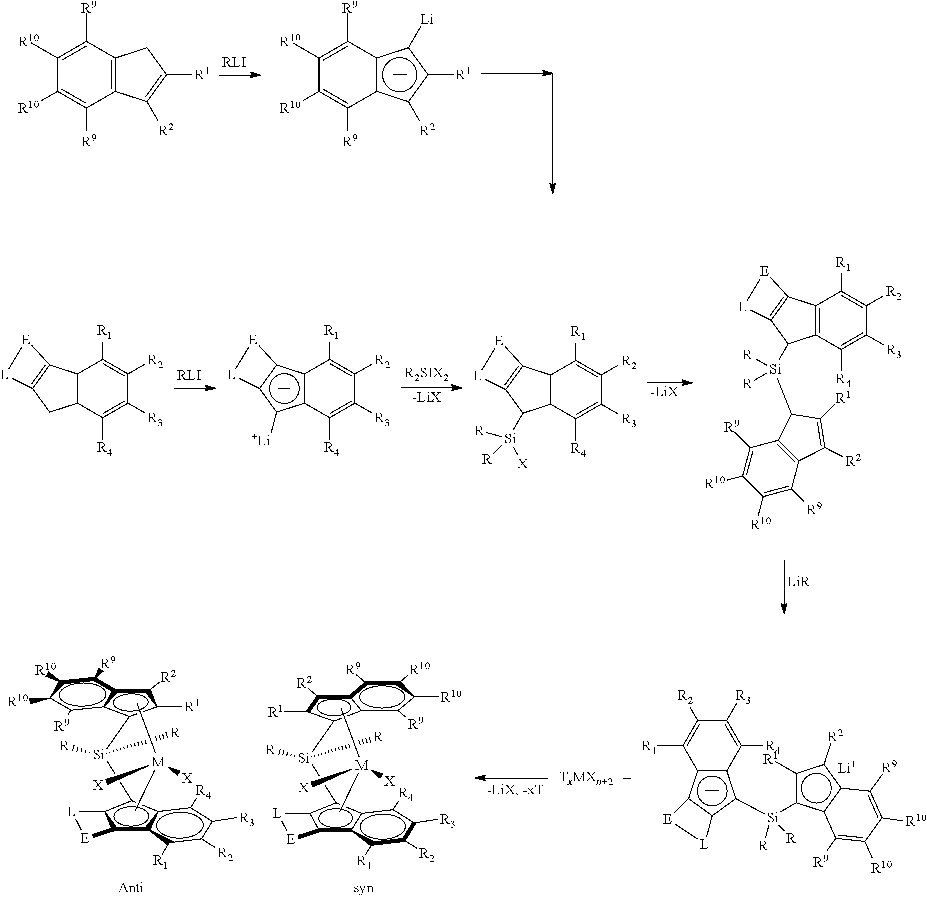

Totally different synthetic routes can be employed with respect to different types of metallocene complexes, in order to achieve the optimum yield and optimum purity of the metallocene complexes. The following reaction equation shows another synthetic route of the same metallocene complex molecule, apparently indicating the diversity of choices for the synthetic route for such metallocene complexes.

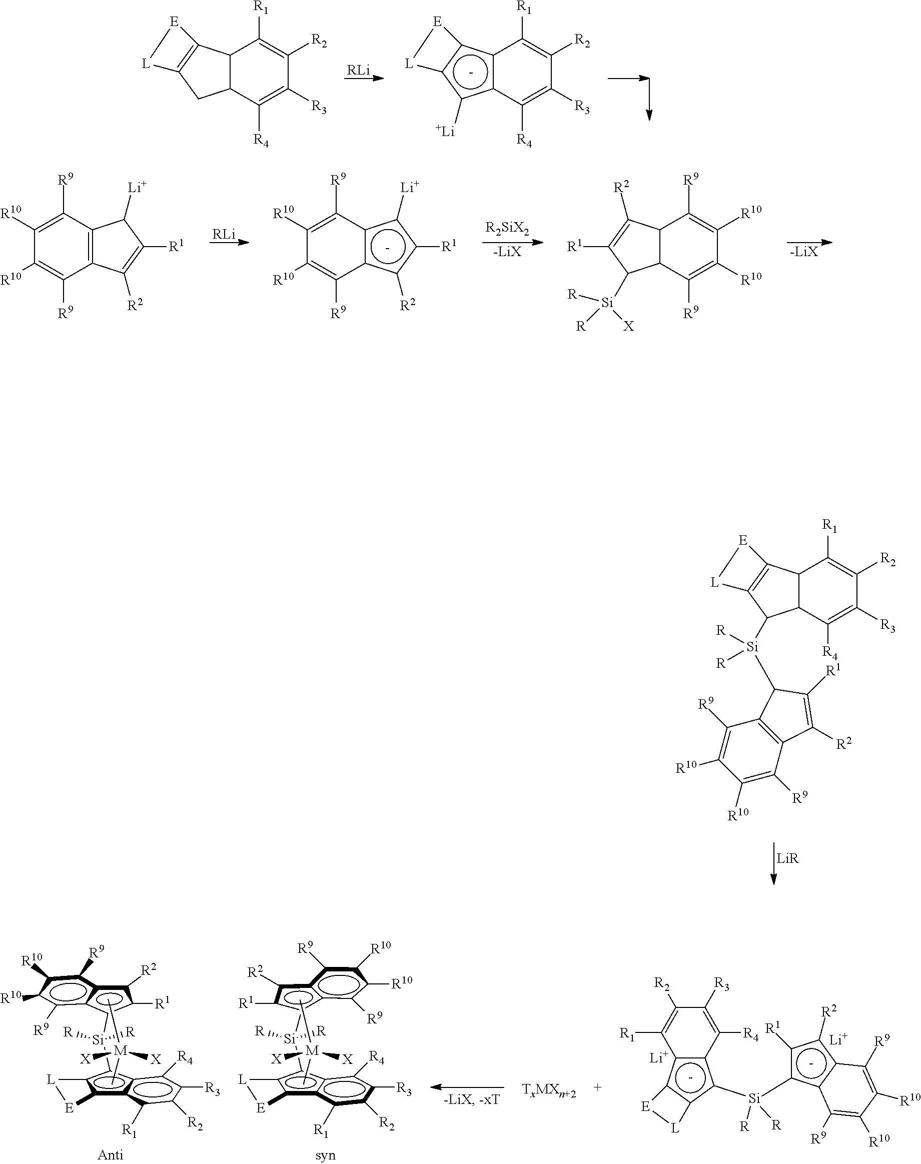

In both reaction equations above,

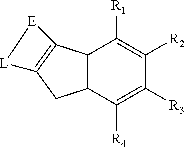

is used as an example for illustration. When formula (II) is

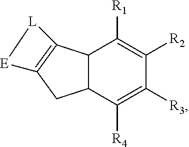

the same reaction process can be carried out with the only exception that the spatial positions of “E” and “L” are exchanged.

2. Novel Catalyst Systems Having a Metallocene Complex with a Heteroatom-Containing π-Ligand as the Core Component

The metallocene complexes synthesized in the present invention are subjected to a specific activation treatment and immobilization to form an active catalyst system. The system is generally composed of a carrier ZT, a cocatalyst ZC, a primary catalyst ZH and an activator HH. The carrier ZT is generally an acidic inorganic oxide with high specific surface area, such as a synthetic or natural inorganic porous- or lamellar-structure material such as SiO₂, Al₂O₃, montmorillonite, kaolin or the like. The cocatalyst ZC is generally a strong Lewis acid material such as polymethylaluminoxane (PMAO), modified MAO (MMAO), organoboron compounds, partially or wholly fluoro-substituted aromatic borane compounds (such as LiB(C₆H₅)₄, B(C₆F₅)₃, LiB(C₆F₅)₄, Ph₃CB(C₆F₅)₄, etc.). The primary catalyst ZH is one of above-synthetized metallocene complexes or a combination of two of the metallocene complexes. The activator HH is any one of chemical materials (such as an alkylaluminum compound, an alkylboron compound, a Grignard agent, organolithium reagents, etc.) which can react in a substitution or exchange reaction with the anion (such as halogen, alkoxy, amino, siloxanyl, etc.) coordinated at the active site of the metallocene and which can allow the metallocene complex to form a neutral or cationic compound. In the preparation of the catalyst system, the four components of ZT, ZC, ZH and HH can be treated and combined according to the polymerization process requirements. The procedures commonly used for combining the targeted catalysts can be described as the following: (1) an activated metallocene catalyst solution is formed with ZH+HH, and then added onto the support cocatalyst formed with ZT+ZC; (2) an active catalyst solution formed with ZH+HH is added to a solution of the cocatalyst ZC and mixed, and then the mixed solution is added onto the carrier ZT; (3) an active catalyst solution formed with ZC+ZH is added onto the carrier ZT, into which the activator HH is finally added (or the activator HH may be omitted); and (4) an active catalyst solution formed with ZH+HH is added to the activated carrier formed with ZT+HH (the cocatlyst ZC may be omitted). The diversity of the processes for preparing the catalyt according to the present invention allows for the development and extending of the adaptation of the polymerization processes of the catalyst system.

The present invention further relates to use of a metallocene complex with a heteroatom-containing π-ligand as the core component to form an active catalyst system for the catalysis of homopolymerization or copolymerization of olefins. Here, the process for preparing the active catalyst system formed by using the novel metallocene complex with a heteroatom-containing π-ligand as the core component is preferably considered.

It is well known that the activation of the metallocene complex or the selection of the activation process directly affects the catalytic efficiency of the catalyst, such as the high-temperature thermal stability of the catalyst (the effective life of the catalyst), the activity of the catalyst (the polymerization output efficiency of the catalyst per unit time), the relative selectivity of the catalyst with regard to the polymerization chain growth rate and the chain elimination rate (the molecular weight and molecular weight distribution of the polymer), the regioselectivity and stereoselectivity of the catalyst's active center to the olefins (the microstructure of the polymer chain). The selection of the activation process (such as activator per se, the ratio of the activator to the metallocene complex, temperature, medium, type of the carrier, physical form of the carrier) also directly affects the apparent morphology of the polymer (condensed-matter physical properties). Therefore, whether the catalytic process is successful and whether the physical and mechanical properties of the polymer is superior are closely related to the activation process of the catalyst.

The formation of the active catalyst system formed by the novel metallocene complex with a heteroatom-containing π-ligand according to the present invention as a core component, i.e., the activation process of the catalyst can be represented by the following general reaction equation (1):

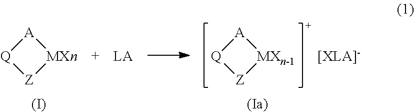

In the general reaction equation (1), the general formula (I) is as defined above. LA is a type of bulky, electron-delocalized Lewis acid substances with poor coordination capability. Representatives of these substances are polymethylaluminoxane (PMAO) having chain, cyclic and cage-like structures in equilibrium in a solution, and the modified polymethylaluminoxane (MMAO) based thereon.

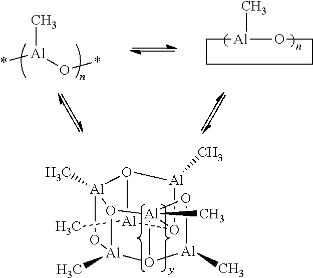

There are still a great number of examples of the bulky, electron-delocalized anion with poor coordination capability according to the present invention such as: [B(C₆H₅)₄]⁻, [(CH₃)B(C₆F₅)₃]⁻, [B(C₆F₅)₄]⁻, [B(2,6-(CH₃)₂—C₆H₃)₄]⁻, [B(2,4,6-(CH₃)₃—C₆H₂)₄]⁻, [B(2,3,5,6-(CH₃)₄—C₆H)₄]⁻, [B(2,6-(CF₃)₂—C₆H₃)₄]⁻, [B(2,4,6-(CF₃)₃—C₆H₂)₄]⁻, [B(2,3,5,6-(CF₃)₄—C₆H)₄]⁻, [B(3,5-(CH₃)₂—C₆H₃)₄]⁻, [B(3,4,5-(CH₃)₃—C₆H₂)₄]⁻, [B(3,5-(CF₃)₂—C₆H₃)₄]⁻, [B(3,4,5-(CF₃)₃—C₆H₂)₄]⁻, [B(2,6-(CF₃)₂—C₆F₃)₄]⁻, [B(2,4,6-(CF₃)₃—C₆F₂)₄]⁻, [B(2,3,5,6-(CF₃)₄—C₆F)₄]⁻, [B(3,5-(CF₃)₂—C₆F₃)₄]⁻, [B(3,4,5-(CF₃)₃—C₆F₂)₄]⁻, [Al(C₆H₅)₄]⁻, [(CH₃)Al(C₆F₅)₃]⁻, [Al(C₆F₅)₄]⁻, [Al(2,6-(CH₃)₂—C₆H₃)₄]⁻, [Al(2,4,6-(CH₃)₃—C₆H₂)₄]⁻, [Al(2,3,5,6-(CH₃)₄—C₆H)₄]⁻, [Al(3,5-(CH₃)₂—C₆H₃)₄]⁻, [Al(3,4,5-(CH₃)₃—C₆H₂)₄]⁻, [Al(2,6-(CH₃)₂—C₆F₃)₄], [Al(2,4,6-(CH₃)₃—C₆F₂)₄]⁻, [Al(2,3,5,6-(CH₃)₄—C₆F)₄]⁻, [Al(3,5-(CH₃)₂—C₆F₃)₄]⁻, [Al(3,4,5-(CH₃)₃—C₆F₂)₄]⁻, [Al(2,6-(CF₃)₂—C₆H₃)₄]⁻, [Al(2,4,6-(CF₃)₃—C₆H₂)₄]⁻, [Al(2,3,5,6-(CF₃)₄—C₆H)₄]⁻, [Al(3,5-(CF₃)₂—C₆H₃)₄]⁻, [Al(3,4,5-(CF₃)₃—C₆H₂)₄]⁻, [Al(2,6-(CF₃)₂—C₆F₃)₄], [Al(2,4,6-(CF₃)₃—C₆F₂)₄]⁻, [Al(2,3,5,6-(CF₃)₄—C₆F)₄], [Al(3,5-(CF₃)₂—C₆F₃)₄]⁻, [Al(3,4,5-(CF₃)₃—C₆F₂)₄]⁻, {t-Bu-CH═C[B(C₆F₅)₂]₂(CH₃)}⁻, {Ph-CH═C[B(C₆F₅)₂]₂(CH₃)}⁻, {(C₆F₅)—CH═C[B(C₆F₅)₂]₂(CH₃)}⁻, {t-Bu-CH═C[Al(C₆F₅)₂]₂(CH₃)}⁻, {Ph-CH═C[Al(C₆F₅)₂]₂(CH₃)}⁻, {(C₆F₅)—CH═C[Al(C₆F₅)₂]₂(CH₃)}⁻, [1,1′-C₁₂F₈- 2,2′=B(C₆F₅)₂]⁻, [1,1′-C₁₂F₈-2,2′=Al(C₆F₅)₂]⁻, [FB(1-C₆F₄-2-C₆F₅)₃]⁻, [(CH₃)B(1-C₆F₄-2-C₆F₅)₃]⁻, [(C₆F₅)B(1-C₆F₄-2-C₆F₅)₃]⁻, [(C₆F₅)Al(1-C₆F₄-2-C₆F₅)₃]⁻, [FAl(1-C₆F₄-2-C₆F₅)₃]⁻, [(CH₃)Al(1-C₆F₄-2-C₆F₅)₃]—, ⁻, [HB(1-C₆F₄-2-C₆F₅)₃]⁻, [HAl(1-C₆F₄-2- C₆F₅)₃]⁻, [(CH₃)B(2-C₁₀F₇)₃]⁻, [(CH₃)Al(2-C₁₀F₇)₃]⁻, [(CH₃)B(p-C₆F₄SiMe₃)₃]⁻, [B(p-C₆F₄SiMe₃)₄]⁻, [(CH₃)B(p-C₆F₄Si(n-Bu)₃)₃]⁻, [B(p-C₆F₄Si(n-Bu)₃)₄]⁻, [(CH₃)B(p-C₆F₄Si(i-Bu)₃)₃]⁻, [B(p-C₆F₄Si(i-Bu)₃)₄]⁻, [(CH₃)B(p-C₆F₄Si(t-Bu)₃)₃]⁻, [B(p-C₆F₄Si(t-Bu)₃)₄]⁻, [(C₆F₅)₃B—C₆F₄—B(C₆F₅)₂]⁻, [C₆F₄-1,2-(B(C₆F₅)₃)₂]⁼, [C₆F₄-1,2-(Al(C₆F₅)₃)₂]⁼, [(C₆F₄)-1,2-(B(C₆F₅)₂)₂-1′,2′-(C₆F₄)]⁼, [(C₆F₄)-1,2-(Al(C₆F₅)₂)₂-1′,2′-(C₆F₄)]⁼, [(C₆F₅)₃B—CN—B(C₆F₅)₃]⁻, [(C₆F₅)₃Al—CN—Al(C₆F₅)₃]⁻, [((C₆F₅)₃BNC)₄Ni]⁼, [((C₆F₅)₃AlNC)₄Ni]⁼, [(1,1′-C₁₂F₈)₂-2,2′-B]⁻, [(1,1′-C₁₂F₈)₂-2,2′-Al]⁻, [B(O—C₆F₅)₄]⁻, [Al(O—C₆F₅)₄]⁻, [(C₆F₅)₃Al—C₆F₄—Al(C₆F₅)₂]⁻, [(CH₃)Al(p-C₆F₄SiMe₃)₃]⁻, [Al(p-C₆F₄SiMe₃)₄]⁻, [(CH₃)Al(p-C₆F₄Si(n-Bu)₃)₃]⁻, [Al(p-C₆F₄Si(n-Bu)₃)₄]⁻, [(CH₃)Al(p-C₆F₄Si(i-Bu)₃)₃]⁻, [Al(p-C₆F₄Si(i-Bu)₃)₄]⁻, [(CH₃)Al(p-C₆F₄Si(t-Bu)₃)₃]⁻, [Al(p-C₆F₄Si(t-Bu)₃)₄]⁻, [C₅(C₆H₅)₅]⁻, [C₅(2,6-(CH₃)₂—C₆H₃)₅]⁻, [C₅(2,4,6-(CH₃)₃—C₆H₂)₅]⁻, [C₅(3,5-(CH₃)₂—C₆H₃)₅]⁻, [C₅(3,4,5-(CH₃)₃—C₆H₂)₅]⁻, [C₅(2,6-(CF₃)₂—C₆H₃)₅]⁻, [C₅(2,4,6-(CF₃)₃—C₆H₂)₅]⁻, [C₅(3,5-(CF₃)₂—C₆H₃)₅]⁻, [C₅(3,4,5-(CF₃)₃—C₆H₂)₅]⁻, [C₅(2,6-(CH₃)₂—C₆F₃)₅]⁻, [C₅(2,4,6-(CH₃)₃—C₆F₂)₅]⁻, [C₅(3,5-(CH₃)₂—C₆F₃)₅]⁻, [C₅(3,4,5-(CH₃)₃—C₆F₂)₅]⁻, [C₅(2,6-(CF₃)₂—C₆F₃)₅]⁻, [C₅(2,4,6-(CF₃)₃—C₆F₂)₅]⁻, [C₅(3,5-(CF₃)₂—C₆F₃)₅]⁻, [C₅(3,4,5-(CF₃)₃—C₆F₂)₅]⁻, [C₅(C₆F₅)₅]⁻, [Li(Ta(OC₆F₅)₄( [symbol] ₂-OC₆F₅)₂)₂]⁻, [Nb(OC₆F₅)₆]⁻, [PF₆]⁻, [AsF₆]⁻, [SbF₆]⁻, [BF₄]⁻, [ClO₄]⁻, and carborane anions such as [C₂B₉H₁₂]⁻ and [CB₁₁H₁₂]⁻; but are not limited thereto.

The catalyst activation reaction represented by the reaction equation (1) is generally carried out in a specific homogeneous liquid medium. There are a variety of liquid media that are commonly used, such as C₅-C₁₂ saturated alkanes and C₆-C₁₂ aromatic hydrocarbons. The optimal liquid medium is capable of completely dissolving the metal complex represented by the structure (I) and the Lewis acid represented by LA to form a homogeneous reaction system. The liquid reaction media that are commonly used include saturated alkanes such as pentane, hexane, heptane, octane, and isomers thereof. Aromatic liquid media include benzene, toluene, xylene and isomers, trimethylbenzene and isomers, chlorobenzene, dichlorobenzene and isomers, fluorobenzene, difluorobenzene and isomers, and polyfluorobenzene and isomers. The most frequently used are pentane and isomers, hexane and isomers, heptane and isomers, toluene, and xylene and isomers. In practice, the most preferred are hexane and isomers, heptane and isomers, toluene, chlorobenzene and the like. A mixed liquid medium of two or more is also used in some cases of the catalyst activation reaction represented by the reaction equation (1). The mixed liquid medium means that saturated alkanes and aromatic hydrocarbons are mixed in a certain volume ratio by percentage, with the volume percentage of one of the liquid media of not less than 5%.

The catalyst activation reaction represented by the reaction equation (1) in a specific homogeneous medium is necessarily carried out within a certain temperature range to form 95% or more of the reaction product (Ia). The reaction temperature can be selected within the range between −100° C. and 250° C., and is generally controlled within a range from −75° C. to 150° C. The optimum reaction temperature range is related to the solubility and reaction properties of the metal complex represented by formula (I) and LA.

The present invention further relates to use of a metallocene complex with a heteroatom-containing π-ligand as the core component to form an active catalyst system for the catalysis of homopolymerization or copolymerization of olefins. The active complex catalyst formed by the above process serves to polymerize alpha-olefins under process conditions for bulk slurry or solvent slurry polymerization.

The use of the metallocene catalyst system described above to polymerize α-olefins such as propylene in the present invention is generally applicable to bulk slurry polymerization processes. It can also be applied to solvent slurry polymerization processes or gas phase polymerization processes upon appropriate adjustments in polymerization conditions and the catalyst.

The use of the metallocene catalyst system described above to copolymerize α-olefins such as propylene with an olefin such as ethylene and other α-olefins such as 1-butene, 1-pentene, 1-hexene and the like in the present invention is generally applicable to bulk slurry polymerization processes. It can also be applied to solvent slurry polymerization processes or gas phase polymerization processes upon appropriate adjustments in polymerization conditions and the catalyst.

The methods for analysis and characterization used in the related techniques of the present invention are as follows:

The ligands and complexes are analyzed by NMR and mass spectrometry; the polymers are analyzed by means of melt index meter, DSC, GPC analyzer, NMR and so on.

Melt index meter: Type 6542, from System Scientific Instrument Ltd., Italy

NMR: AV400, BRUKER, Germany

Mass Spectrometer: 5973N, Agilent, USA

DSC analyzer: 200F3, NETZSCH, Germany

GPC Analyzer: Waters2000, Waters, USA

### Example 1

Synthesis of Intermediate a₁:

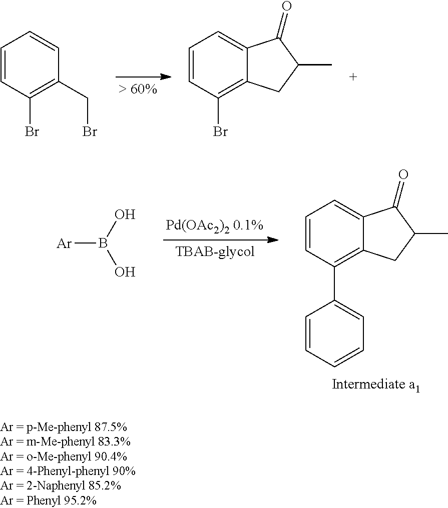

Synthesis of Intermediate a₁ in the Reaction Equation:

Phenylboronic acid was used as substrate, and the catalyst, tetrabutylammonium bromide (TBAB), and ethylene glycol were separated from the product by using 3:1 PE/EA (petroleum ether/ethyl acetate) and repeatedly used (TBAB and ethylene glycol). An isolated yield after the third reaction of 82.2% was achieved.

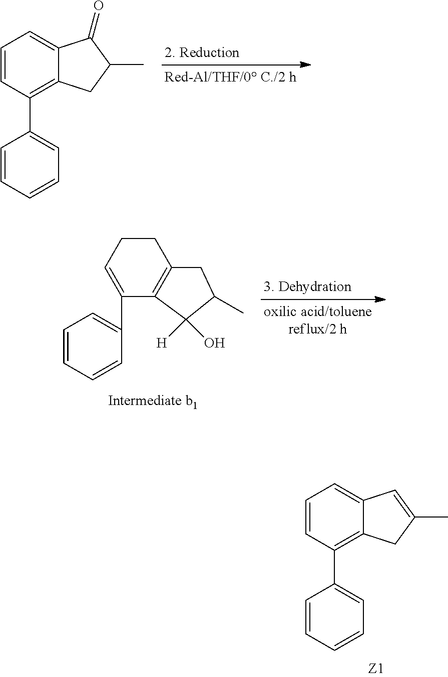

Synthesis of Intermediate b₁:

5 mmol of Intermediate a₁ was weighed and put into a 100 ml two-necked reaction flask, 40 ml of THF (tetrahydrofuran) was added thereto, and the flask was placed in an ice water bath to be fully cooled; 5 mmol of Red-Al (sodium bis(2-methoxyethoxy)aluminum dihydride) was added dropwise over 15 min. The reaction was carried out for 2 hours, and then the temperature was raised to room temperature to react overnight at room temperature. A 10% HCl solution was prepared and added dropwise to the reaction system, a white solid was precipitated and the system was made acidic. The resultant was suction-filtered by a Buchner funnel, and the organic phase was collected. The white solid was extracted twice with THF, and the extraction solution was collected. The organic phase and the extraction solution were combined and dried. A crude product was obtained by rotary-evaporation drying, with a yield of 68.4%.

Synthesis of Ligand Z₁:

Intermediate b₁ was dissolved in toluene, and oxalic acid and a 4 A molecular sieves were added thereto. The mixture was refluxed at 120° C. for 2 h. During the reaction, thin-layer chromatography was used to verify whether the reaction was complete. After the reaction was complete, the resultant was washed with an excessive amount of a sodium bicarbonate solution, and then the organic phase was separated. The aqueous layer was extracted three times with ethyl acetate. The organic phase was combined and dried. The solvent was removed by rotary evaporation to give ligand Z₁ with a yield of 84%.

Synthesis of A₁:

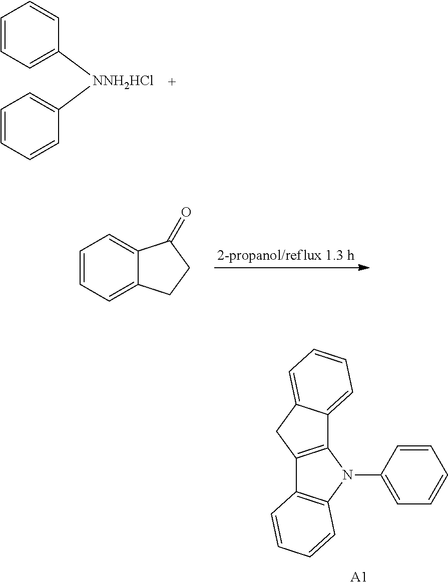

The raw materials were weighed as calculated based on 1 mol of the product, and placed in 2000 ml one-port reaction flask, and then isopropyl alcohol was added thereto. The temperature of the oil bath was gradually raised to 80° C., while the reaction was carried out with stirring under reflux for 1.3 h. Then, the temperature was lowered to room temperature, a dark brown solution was obtained and washed with a NaHCO₃ solution to give a brown suspension, which was filtered to give 26.5 g brown powder-like solid (theoretical yield: 28.1 g). The product was purified by column chromatography to obtain ligand A₁ with a yield of 94.3%.

Synthesis of a Zirconium Dichloride Complex:

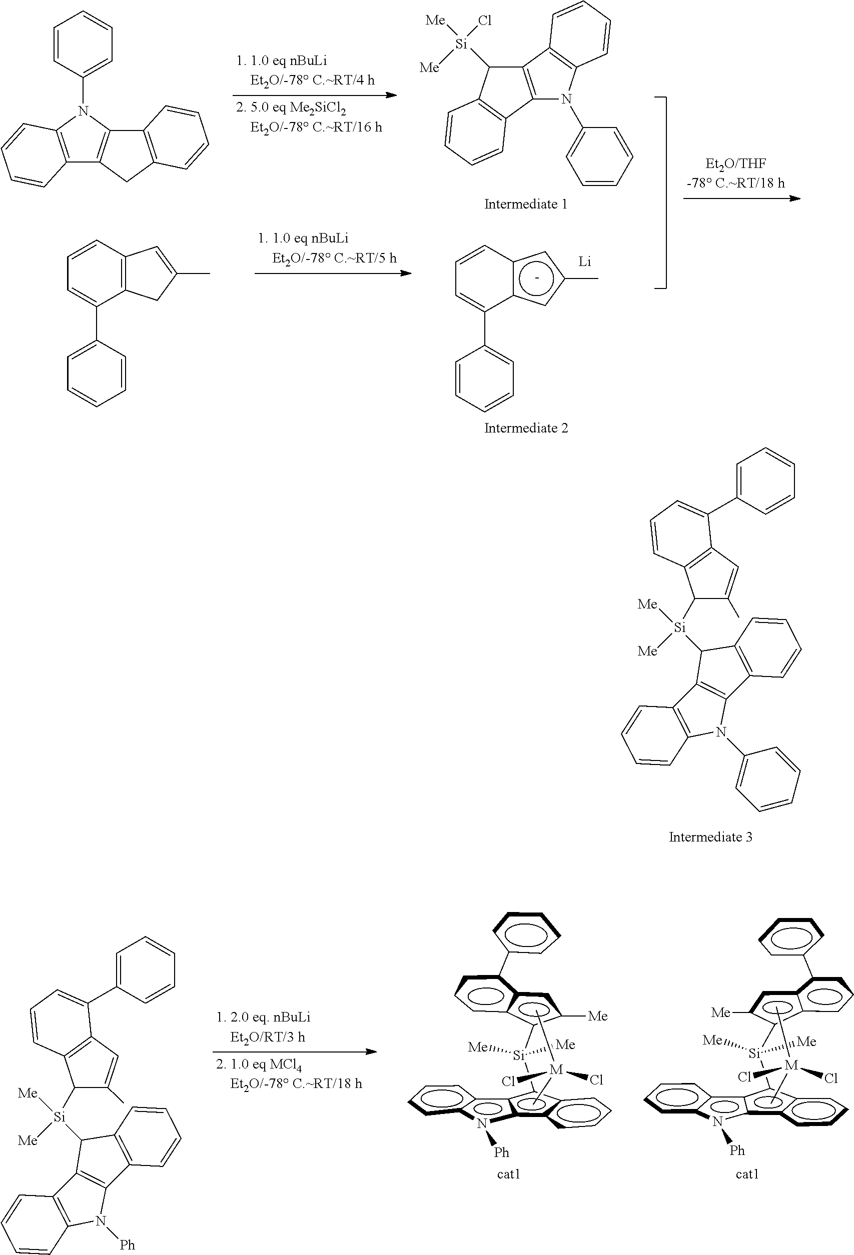

Synthesis of Intermediate 1 in the Reaction Equation:

Ligand A₁ (Fw=281.35, 28.14 g, 100 mmol) was weighed and placed in a 1000 mL two-necked round bottom flask in a glove box. The flask was removed from the glove box and transferred to the Sclenk system. The ligand was dissolved in 500 mL of anhydrous ether in a high-purity nitrogen atmosphere. The round bottom flask was placed in an ice-water bath at or below 0° C. to be cooled, and a solution of n-butyllithium in hexane (2.40 M/L solution, 44 ml, 105 mmol) was slowly added dropwise in a high-purity nitrogen atmosphere under continuous stirring. Upon the completion of the dropwise addition, the reaction system was naturally warmed to room temperature to obtain a dark red solution. The reaction was kept warm at 25° C. for 4 h. The organolithium solution prepared as above was slowly added dropwise to a solution (30 mL, <0° C.) of dimethyldichlorosilance (Me₂SiCl₂, Fw=129.06, d=1.07 g/mL, 60.0 ml, 500 mmol) in anhydrous ether by using a Teflon capillary under nitrogen protection. The reaction was stirred overnight under nitrogen protection. LiCl was filtered out by siphoning filtration under nitrogen protection. The remaining solid LiCl was extracted and washed with a small amount of anhydrous ether and filtered by siphoning. The combined filtrate was evacuated to remove the solvent and unreacted Me₂SiCl₂ to give Intermediate 1 with a yield of 98%.

Synthesis of Intermediate 2 in the Reaction Equation:

The organic molecule, 2-methylbenzindene (Fw=180.25, 18.02 g, 100 mmol), was weighed and placed in a 1000 mL two-necked round bottom flask in an inert-gas glove box. The flask was removed from the glove box and transferred to the Sclenk system. The above 2-methylbenzindene was dissolved in 500 mL of anhydrous ether under high-purity nitrogen protection. The round bottom flask was placed in an ice-water bath at or below 0° C. A solution of n-butyllithium in hexane (2.40 M/L, 41.6 ml, 100 mmol) was slowly added dropwise to the above solution of 2-methylbenzindene in ether. Upon the completion of the dropwise addition, the reaction system was kept warm at 25° C. for 5 h to produce a solution of 2-methylbenzindene lithium salt in ether (Intermediate 2).

Synthesis of Intermediate 3 in the Reaction Equation:

The above Intermediate 1 was dissolved in anhydrous ether (500 mL) under nitrogen protection, and cooled to below 0° C. The solution of Intermediate 2 in ether was slowly added dropwise to the solution of Intermediate 1 in ether by capillary siphoning. Upon the completion of the dropwise addition, the system was naturally warmed to room temperature, and stirred overnight at 28° C. in a high-purity nitrogen atmosphere. The dark red solution was removed from LiCl by siphoning filtration. The remaining solid was extracted and washed once with a small amount of anhydrous ether and filtered by siphoning. The combined filtrate was removed from solvent under reduced pressure, and then vacuum dried to a constant weight, so as to obtain Intermediate 3 having a purity of above 95%.

In an inert-gas glove box, Intermediate 3 (Fw=517.74, 20.92 g, 40.4 mmol) was weighed and placed in a 1000 mL two-necked round bottom flask. The flask was removed from the glove box and transferred to the Sclenk system. The above Intermediate 3 was dissolved in 500 mL anhydrous ether under high-purity nitrogen protection. The round bottom flask was placed in an ice-water bath below 0° C. A solution of n-butyllithium in hexane (2.40 M/L, 33.6 ml, 80.8 mmol) was slowly added dropwise to the above solution of Intermediate 3 in ether. Upon the completion of the dropwise addition, the reaction system was kept warm at 25° C. for 5 h to produce a solution of a lithium salt of Intermediate 3 in ether.

In an inert-gas glove box, ZrCl₄ (Fw=233.04, 9.4 g, 40.4 mmol) was weighed and placed in a 500 mL two-necked round bottom flask. The flask was removed from the glove box and transferred to the Sclenk system. 250 mL anhydrous ether was added to the ZrCl₄ solid cooled at or below 0° C. (in an ice-brine bath) under high-purity nitrogen protection and continuous stirring. The solution of the lithium salt of Intermediate 3 in ether was slowly added dropwise to the suspension of ZrCl₄ by capillary siphoning. Upon completion of the dropwise addition, the reaction was kepted warm at 25° C. for 19 h to produce a quasi-C2 symmetric zirconocene complex. The reaction suspension having a cherry red appearance was subjected to solvent removal under reduced pressure, vacuum dried to a constant weight, to afford a crude quasi-C2 symmetric zirconocene complex. NMR analysis of the crude product showed that the impurity was mainly hexane and a large amount of LiCl and the complex had a purity of greater than 95%.

A 5 L autoclave was evacuated and replaced with nitrogen gas three times. Then, 3600 μmol of an MAO (methylaluminoxane) solution and 1000 g propylene were added into the autoclave. 8 μmol of a zirconium dichloride complex and 400 μmol of the MAO (methylaluminoxane) were activated at room temperature for 30 mins, and then charged into the autoclave with high-pressure nitrogen gas. After the temperature was raised to 65° C., polymerization reaction was carried out for 1 h to obtain 139 g of a polymerization product, with a catalyst activity of 1.74×10⁷ gPP/molcat·h, a molecular weight Mw of 22.5, a distribution of 2.0, and an isotacticity of 87%.

### Example 2

This Example was carried out under the conditions as those in Example 1, except that Z₂ was synthesized as below:

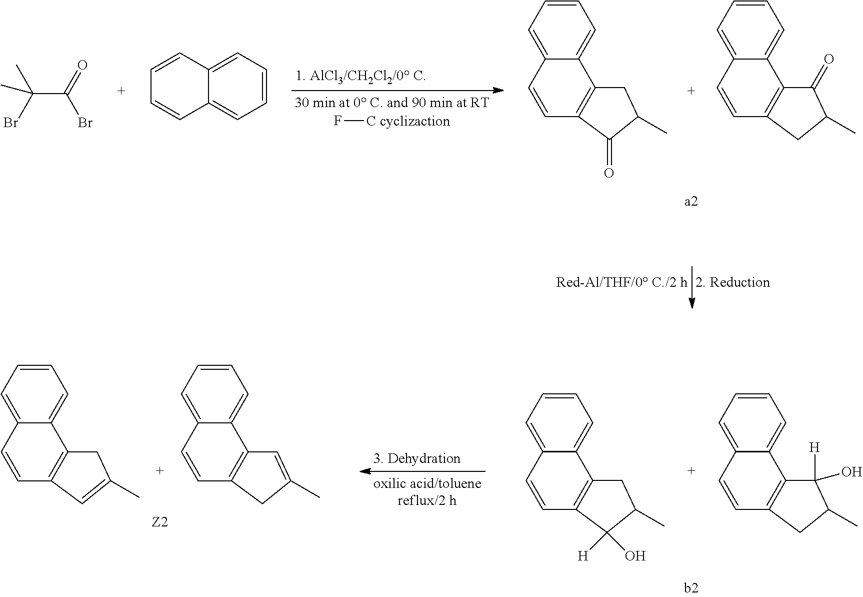

Synthesis of Intermediate a₂ as a Product:

The raw materials were weighed according to calculation based on 1 mol of the product and placed in a 2500 ml two-necked reaction flask, and then stirred in an ice-water bath for 20 mins. Dibromo-2-methylpropionyl bromide and anhydrous dichloromethane were weighed and added into a separating funnel, and slowly added dropwise into the reaction flask. Naphthalene and anhydrous dichloromethane were weighed and added to a separating funnel, rapidly dissolved, and then slowly added dropwise to the reaction system. The color of solution in the reaction flask quickly became yellow, and then gradually turned brown red. Then, anhydrous dichloromethane was added to rinse the separating funnel. The reaction continued for 30 min before ice was removed and the temperature of the water bath slowly increased to room temperature. The reaction continued until emission of HBr gas was observed, which was regarded as the reaction endpoint. The resultant was washed with a large amount of water to remove impurities and unreacted raw materials, and the organic phase was collected upon liquid separation. The product in the water phase was extracted with anhydrous dichloromethane, which was repeated for three times. The extraction phase and the organic phase were combined and dried. The solvent was distilled off with a rotary evaporator to purify the crude product a₂, yield: 64.5%.

Synthesis of Intermediate b₂ as a Product:

Intermediate a₂ was weighed and put into a 1000 ml two-necked reaction flask, 400 ml of THF was added thereto, and the flask was placed in an ice bath to be sufficiently cooled down; Red-Al was added dropwise over 15 min. The reaction was carried out for 2 hours, warmed to room temperature, and continued at room temperature overnight. A 10% HCl solution was prepared and added dropwise to the reaction system, a white solid was precipitated and the system was made acidic. The resultant was suction-filtered by a Buchner funnel, and the organic phase was collected. The white solid was extracted twice with THF, and the extraction solution was collected. The organic phase and the extraction solution were combined and dried. A crude product was obtained by rotary-evaporation drying, with a yield of 68.4%.

Synthesis of Ligand Z₂:

Intermediate b₂ was dissolved in toluene, and oxalic acid and a 4 A molecular sieves were added thereto. The mixture was refluxed at 120° C. for 2 h. During the reaction, thin-layer chromatography was used to verify whether the reaction was complete. After the reaction was complete, the resultant was washed with an excessive amount of a sodium bicarbonate solution, and then the organic phase was separated. The aqueous layer was extracted three times with ethyl acetate. The organic phase was combined and dried. The solvent was removed by rotary evaporation to give the ligand Z₂ with a yield of 84%. The final yield was 37.1%.

The polymerization reaction was carried out according to the conditions in Example 1, except that the zirconium dichloride complex was prepared by reaction using ligand Z₂ and ligand A₁, to obtain 255 g of the polymerization product, with a catalyst activity of 3.19×10⁷ gPP/molcat·h, a molecular weight Mw of 24.5, a distribution of 2.0, and an isotacticity of 76%.

### Example 3 to Example 24

According to the conditions in Example 1, the structure and synthetic process of Intermediate a were as follows:

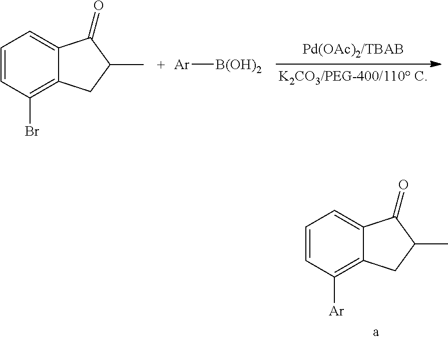

The following materials were weighed in this order: 4-bromo-2-methyl-1-indanone (0.056 g, 0.25 mmol), phenylboronic acid Ar—B(OH)₂ (0.3 mmol), potassium carbonate K₂CO₃ (0.069 g, 0.5 mmol), PEG-400 (Ethylene glycol-400) (2 g), tetrabutylammonium bromide TBAB (0.08 g, 0.25 mmol), and a catalyst palladium acetate Pd(OAc)₂ was added thereto. The resultant was heated and stirred at 110° C. The results are shown in the table below.

| | | n | m | Pd(OAc)₂ | TLC | Time | Yield |
|---|---|---|---|---|---|---|---|
| Items | Ar—B(OH)₂ | (mmol) | (g) | (mmol) | (P/E = 4:1) | (h) | (%) |
| (1) | 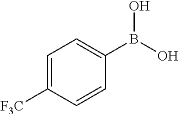 [SMILES: OB(O)c1ccc(C(F)(F)F)cc1] | 0.3 0.3 0.6 | 0.057 0.057 0.114 | *5% *1% *5% | Rfr = 0.579 Rfp = 0.447 Rfr = 0.684 Rfp = 0.553 Rfr = 0.579 Rfp = 0.447 | 6 | 83.33% 41.38% 88.33% |
| (2) | 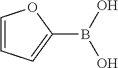 | 0.3 | 0.034 | *5% *1% | Rfr = 0.579 Rfp = 0.446 Rfr = 0.684 Rfp = 0.63 | 6 | 73.58% 47.17% |
| (3) | 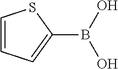 | 0.3 | 0.038 | *5% *1% | Rfr = 0.579 Rfp = 0.446 Rfr = 0.67 Rfp = 0.59 | 6 | 57.89% 43.86% |
| (4) | 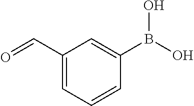 [SMILES: O=Cc1cccc(B(O)O)c1] | 0.3 | 0.045 | *5% *1% | Rfr = 0.579 Rfp = 0.289 Rfr = 0.67 Rfp = 0.32 | 6 | 69.35% 36% |
| (5) | 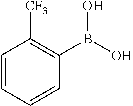 [SMILES: OB(O)c1ccccc1C(F)(F)F] | 0.3 | 0.057 | *5% *1% | Rfr = 0.579 Rfp = 0.5 Rfr = 0.67 Rfp = 0.58 | 15 | 77.78% 41.38% |
| (6) | 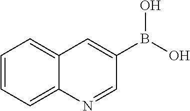 [SMILES: OB(O)c1cnc2ccccc2c1] | 0.3 0.3 0.6 | 0.052 0.052 0.103 | *5% *1% *5% | Rfr = 0.54 Rfp = 0.135 Rfr = 0.67 Rfp = 0.26 Rfr = 0.54 Rfp = 0.135 | 6 | 58.25% 40.44% 44.12% |
| (7) | 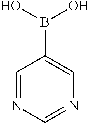 | 0.3 0.3 0.6 | 0.037 0.037 0.074 | *5% *1% *5% | Rfr = 0.54 Rfp = 0.11 Rfr = 0.67 Rfp = 0.18 Rfr = 0.54 Rfp = 0.11 | 6 24 6 | 68.75% 48.22% 77 mg 68.75% |
| (8) | 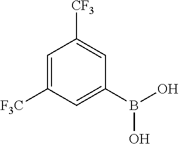 [SMILES: OB(O)c1cc(C(F)(F)F)cc(C(F)(F)F)c1] | 0.3 | 0.077 | *5% 0.5*1% | Rfr = 0.54 Rfp = 0.46 Rfr = 0.458 Rfp = 0.32 | 6 | 80.52% 54.75% |
| (9) | 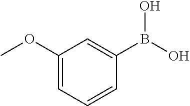 | 0.3 | 0.046 | *5% 0.5*1% | Rfr = 0.54 Rfp = 0.5 Rfr = 0.458 Rfp = 0.278 | 6 | 77.78% 74.6% |
| (10) | 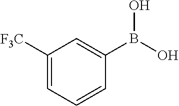 [SMILES: OB(O)c1cccc(C(F)(F)F)c1] | 0.3 | 0.057 | *5% *1% | Rfr = 0.54 Rfp = 0.473 Rfr = 0.458 Rfp = 0.33 | | 93.10% 61.32% |
| (11) | 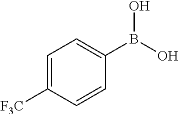 [SMILES: OB(O)c1ccc(C(F)(F)F)cc1] | 0.3 | 0.047 | *5% | (P/E = 10:1) Rfr = 0.42 Rfp = 0.33 | 10 | 67.18% |
| (12) | 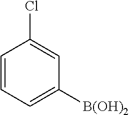 | 0.3 | 0.047 | *5% | (P/E = 10:1) Rfr = 0.42 Rfp = 0.33 | 10 | 65.16% |
| (13) | 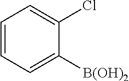 | 0.3 | 0.047 | *5% | (P/E = 10:1) Rfr = 0.42 Rfp = 0.33 | 10 | 79.69% |
| (14) | 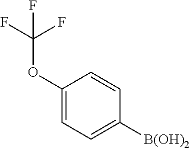 [SMILES: OB(O)c1ccc(OC(F)(F)F)cc1] | 0.25 | 0.062 | *5% | (P/E = 10:1) Rfr = 0.41 Rfp = 0.22 | 10 | 68.42% |
| (15) | 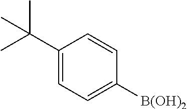 | 0.25 | 0.053 | *5% | (P/E = 10:1) Rfr = 0.41 Rfp = 0.31 | 10 | 78.26% |
| (16) | 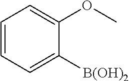 | 0.25 | 0.045 | *5% | (P/E = 10:1) Rfr = 0.41 Rfp = 0.22 | 10 | 78.68% |
| (17) | 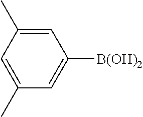 | 0.25 | 0.045 | *5% | (P/E = 10:1) Rfr = 0.41 Rfp = 0.31 | 10 | 85.32% |
| (18) | 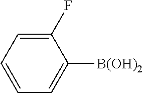 | 0.25 | 0.042 | *5% | (P/E = 10:1) Rfr = 0.47 Rfp = 0.38 | 17 | 80.51% |
| (19) | 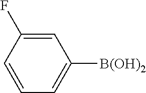 | 0.25 | 0.042 | *5% | (P/E = 10:1) Rfr = 0.47 Rfp = 0.38 | 10 | 85.33% |
| (20) | 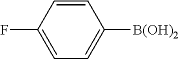 | 0.25 | 0.042 | *5% | (P/E = 10:1) Rfr = 0.47 Rfp = 0.36 | 10 | 86.67% |
| (21) | 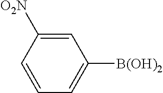 [SMILES: O=[N+]([O-])c1cccc(B(O)O)c1] | 0.25 | 0.05 | *5% | (P/E = 10:1) Rfr = 0.47 Rfp = 0.38 | 10 | 80.96% |
| (22) | 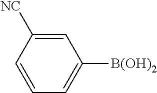 [SMILES: N#Cc1cccc(B(O)O)c1] | 0.25 | 0.044 | *5% | (P/E = 10:1) Rfr = 0.68 Rfp = 0.38 | 10 | 80.16% |

Synthesis of Intermediate b in the Reaction Equation:

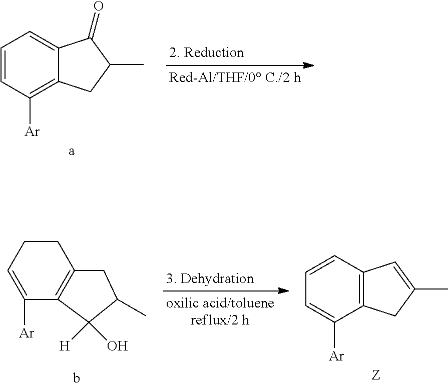

3 mmol of Intermediate a was weighed and put into a 100 ml two-necked reaction flask, 40 ml of THF was added thereto, and the flask was placed in an ice bath to be fully cooled; Red-Al was added dropwise over 15 mins. The reaction was carried out for 2 hours before the temperature was raised to room temperature, and the reaction continued at room temperature overnight. A 10% HCl solution was prepared and added dropwise to the reaction system, a white solid was precipitated, and the system was made acidic. The resultant was suction-filtered by a Buchner funnel, and the organic phase was collected. The white solid was extracted twice with THF, and the extraction solution was collected. The organic phase and the extraction solution were combined and dried. A crude product was obtained by rotary-evaporation drying.

Synthesis of Ligand Z in the Reaction Equation:

2 mmol of Intermediate b was dissolved in toluene, and oxalic acid and a 4 A molecular sieves were added thereto. The mixture was refluxed at 120° C. for 2 h. During the reaction, thin-layer chromatography was used to verify whether the reaction was complete. After the reaction was complete, the resultant was washed by an excessive amount of a sodium bicarbonate solution, and then the organic phase was separated. The aqueous layer was extracted three times with ethyl acetate. The organic phase was combined and dried. The solvent was removed by rotary evaporation to give the ligand.

22 ligands Z were thus obtained. 22 zirconium dichloride complexes were obtained according to the conditions in Example 1 and subjected to polymerization reaction, and the results obtained are shown below.

| | Activities of | | Molcular | |
|---|---|---|---|---|
| | Catalysts × 10⁷ | Molecular | Weight | Isotacticity |
| Items | gPP/molcat · h | Weight M_{w} | Distribution | % |
| Example 3 | 8.25 | 29 | 2.0 | 72 |
| Example 4 | 0.55 | 19 | 2.1 | 56 |
| Example 5 | 0.75 | 21 | 2.0 | 67 |
| Example 6 | 1.64 | 21 | 2.3 | 60 |
| Example 7 | 3.30 | 19 | 2.2 | 73 |
| Example 8 | 36.25 | 28 | 2.0 | 78 |
| Example 9 | 4.50 | 24 | 2.1 | 93 |
| Example 10 | 18.30 | 26 | 2.0 | 88 |
| Example 11 | 5.15 | 21 | 1.9 | 84 |
| Example 12 | 0.15 | 26 | 2.0 | 45 |
| Example 13 | 0.36 | 21 | 2.0 | 55 |
| Example 14 | 1.12 | 18 | 1.9 | 60 |
| Example 15 | 10.35 | 28 | 2.0 | 85 |
| Example 16 | 0.85 | 22 | 2.0 | 74 |
| Example 17 | 1.45 | 24 | 2.1 | 85 |
| Example 18 | 7.35 | 25 | 2.0 | 82 |
| Example 19 | 0.76 | 19.5 | 1.9 | 65 |
| Example 20 | 10.55 | 27 | 2.0 | 78 |
| Example 21 | 4.25 | 21 | 1.9 | 78 |
| Example 22 | 7.45 | 24 | 2.0 | 84 |
| Example 23 | 13.25 | 19 | 2.0 | 72 |
| Example 24 | 6.50 | 16 | 1.9 | 66 |

### Example 25

This Example was carried out according to the procedures in Example 1, except that Compound A₁ was changed into a compound having a structure as below, without any other changes.

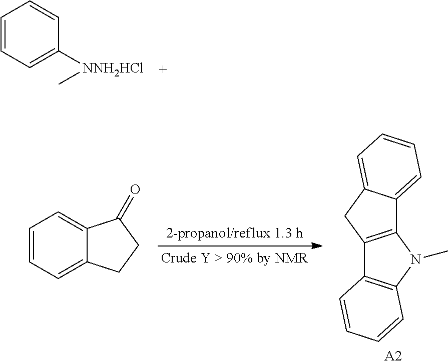

Synthesis of Compound A₂:

2.65 g of 1-indanone was weighed and placed in a 250 ml two-necked flask, and then 100 mL of isopropyl alcohol was added thereto. The mixture was slowly stirred until the solid was completely dissolved. Then, 20 mmol of phenylhydrazine hydrochloride (1.0 equivalent) was slowly added. After the addition, the reaction mixture was stirred at room temperature for 30 mins and then slowly heated to reflux in an oil bath. The mixture was refluxed for 1.3 hours before the heating was discontinued, and then cooled to room temperature. A small amount of solid was precipitated.

Working-up: 50 mL of saturated sodium bicarbonate solution was prepared and slowly added to the solution obtained as above, which was stirred continuously before a large amount of solid was precipitated, followed by filtration. The filter cake was then washed with a sodium bicarbonate solution and water to give 5.1 g brown solid, with a yield of 98%.

The polymerization was carried out according to the polymerization conditions in Example 1, except that 8 μmol of zirconium dichloride complex obtained by using the compound having the structure of A₂ and the compound having the structure of Z₁ was used for polymerization to obtain 155 g of a polymerization product, with a catalyst activity of 1.94×10⁷ gPP/molcat·h, a molecular weight Mw of 24, a distribution of 2.0, and an isotacticity of 85%.

### Example 26

This Example was carried out according to the procedures in Example 1, except that 30 g of 1-hexene was added in the polymerization process, to obtain 220 g of a polymerization product, with a catalyst activity of 2.75×10⁷ gPP/molcat·h, a molecular weight Mw of 20, a distribution of 2.4, and an isotacticity of 71%.

### Example 27

This Example was carried out according to the procedures in Example 1, except that 2.4 mmol of triisobutyl aluminium was added in the polymerization process, without any other changes, to obtain 184 g of a polymerization product, with a catalyst activity of 2.3×10⁷ gPP/molcat·h, a molecular weight Mw of 25.5, a distribution of 2.0, and an isotacticity of 88%.

### Example 28

This Example was carried out according to the procedures in Example 1, except that the metallocene complex with the π-ligand was synthesized at a reaction temperature of −75° C., with out any other conditions changes, to obtain 95 g of a polymerization product, with a catalyst activity of 1.06×10⁷ gPP/molcat·h, a molecular weight Mw of 19.5, a distribution of 2.1, and an isotacticity of 80%.

### Example 29

This Example was carried out according to the procedures in Example 1, except that, in the polymerization process, 2 L of dehydrated hexane was added and then a polymer-grade propylene was introduced, to obtain 45 g of a polymerization product, with a catalyst activity of 0.56×10⁷ gPP/molcat·h, a molecular weight Mw of 27.4, a distribution of 2.2, and an isotacticity of 88%.

### Example 30

This Example was carried out according to the procedures in Example 1, except that the metallocene complex with the π-ligand was synthesized at a reaction temperature of 150° C., with the other conditions unchanged, to obtain 255 g of a polymerization product, with a catalyst activity of 3.19×10⁷ gPP/molcat·h, a molecular weight Mw of 24.8, a distribution of 2.1, and an isotacticity of 91%.

### Example 31

The syntheses of Intermediates a₁ and b₁, and Ligand Z₁ were the same as those in Example 1.

Synthesis of A₁:

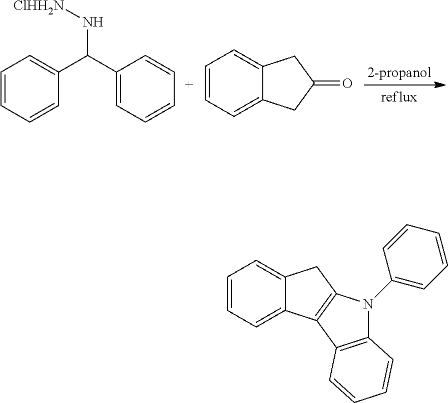

2.65 g of 2-indanone (20 mmol) was weighed and placed in a 250 ml two-necked flask, and then 100 mL of isopropyl alcohol was added thereto. The mixture was slowly stirred until the solid was completely dissolved. Then, 4.5 g of 1,1-diphenylhydrazine hydrochloride (20 mmol, 1.0 equivalent) was slowly added. After the addition, the reaction mixture was stirred at room temperature for 30 mins and then slowly heated to reflux in an oil bath. The mixture was refluxed for 2 hours before the heating was discontinued, and then cooled to room temperature. A small amount of solid was precipitated.

Working-up: 50 mL of saturated sodium bicarbonate solution was prepared and slowly added to the above resulting solution, which was stirred continuously before a large amount of solid was precipitated, followed by filtration. The filter cake was then washed with a sodium bicarbonate solution and water to give 4.1 g brown solid, with a yield of 73%.

Synthesis of a zirconium dichloride complex:

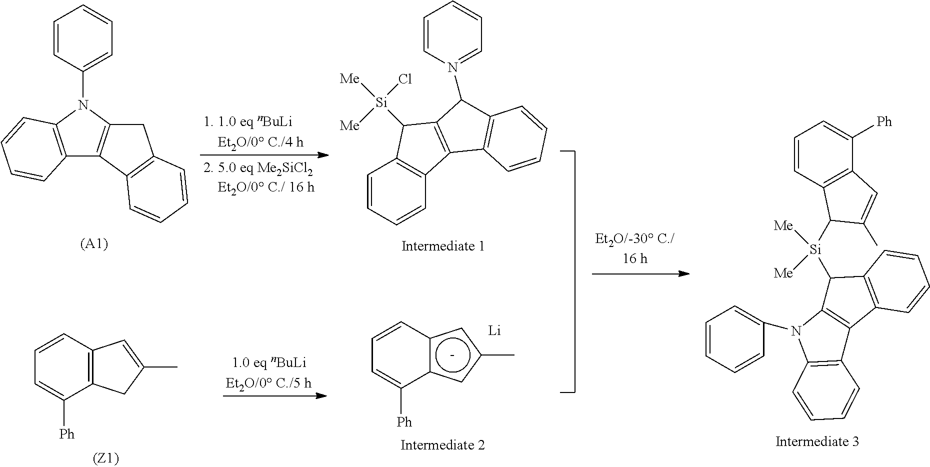

0.64 g of ligand A₁ (Fw=219.28, 2.9 mmol) was weighed in an ampoule, and then dissolved in 30 mL of anhydrous ether that was added thereto. The ampoule was placed in a 0° C. ice-water bath under high purity N₂ protection to be cooled and stirred, and 1.75 mL of nBuLi/hexane (2.01 mol/L, 3.5 mmol) was slowly added dropwise thereinto with a syringe. Upon completion of the dropwise addition, the reaction system was naturally warmed to room temperature to obtain a dark red solution. The reaction was stirred at room temperature for 4 h. The above lithium salt solution was slowly added dropwise to a solution containing 1.75 mL of dimethyldichlorosilance (Me₂SiCl₂, Fw=129.04, d=1.07 g mL, 14.5 mmol) in anhydrous ether (20 mL) in a 0° C. ice-water bath under N₂ protection. The solution had a dark red appearance, and a large amount of LiCl was produced. The reaction was stirred overnight at room temperature, and suction-dried to obtain Intermediate 1 as a grey white solid.

0.60 g of ligand Z₁ (Fw=206.28, 2.9 mmol) was weighed and transferred to an ampoule and then dissolved in 20 mL of anhydrous ether that was added thereto to obtain a colorless solution. The ampoule was placed in a 0° C. ice-water bath under protection of high purity N₂ to be cooled and stirred, and 1.45 mL of nBuLi/hexane (2.01 mol/L, 2.9 mmol) was slowly added dropwise thereinto with a syringe. The reaction system was warmed naturally while the solution turned from colorless to yellow, and finally to orange yellow. After stirring at room temperature for 5 h, Intermediate 2 was obtained.

After 5 h, Intermediate 1 upon suction-drying was dissolved in 30 mL of anhydrous ether to obtain a dark red solution. The solution of Intermediate 1 in ether was placed in a −30° C. low-temperature bath, cooled and stirred. The solution of Intermediate 2 in ether was slowly added dropwise to Intermediate 1 over 15 mins. Upon completion of the dropwise addition, the reaction system was warmed naturally to obtain a dark red solution, which was stirred overnight at room temperature. LiCl was removed, and the solvent was distilled off by rotary evaporation to obtain Intermediate 3, overall yield: 38.6%.

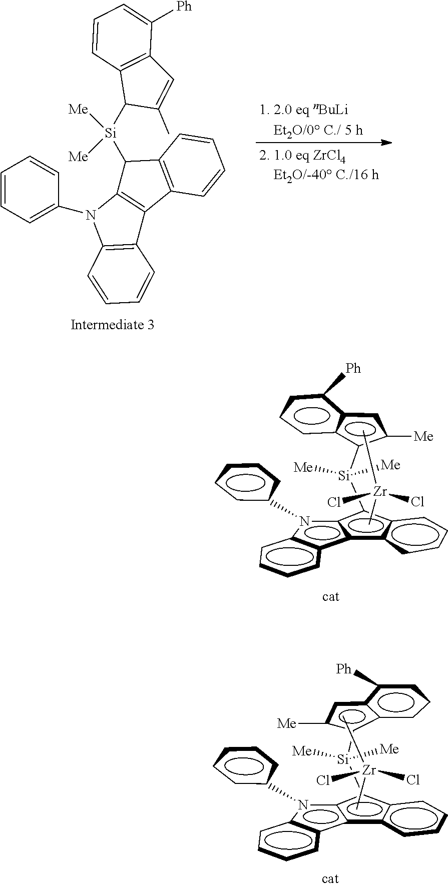

The above Intermediate 3 (Fw=481.70, 1.12 mmol, 540 mg) was dissolved in anhydrous ether to obtain a grey white suspension. The ampoule was placed in a 0° C. ice-water bath to be cooled and stirred. Under protection of N₂, 1.42 mL of nBuLi/hexane (1.6 mol/L, 2.24 mmol) was slowly added thereinto. The unsoluble substances dissolved gradually, and the solution became yellow. The mixture was naturally warmed to room temperature, followed by stirring at room temperature for 5 h, to produce a solution of the lithium salt of Intermediate 3. 0.262 g of ZrCl₄ (Fw=233.04, 1.12 mmol) was taken from a glove box and put into an ampoule, into which 30 mL of anhydrous ether was added under protection of N₂. The solution of ZrCl₄ in ether was placed in a −40° C. low-temperature bath, cooled and stirred. The above solution of the lithium salt of Intermediate 3 was slowly added to the ZrCl₄ suspension over 20 mins. Upon completion of the dropwise addition, the resultant was warmed naturally to room temperature, and stirred overnight at room temperature to produce a zirconium dichloride complex. A yellow solid was precipitated, which was filtered and suction-dried to obtain 482 mg product as an orange solid with a yield of 66.7%.

A 5 L autoclave was evacuated and replaced with nitrogen gas three times. Then, 3600 μmol of an MAO (methylaluminoxane) solution and 1000 g of propylene were added into the autoclave. 8 μmol of a zirconium dichloride complex and 400 μmol of MAO (methylaluminoxane) were activated at room temperature for 30 mins, and then pressurized into the autoclave with high-pressure nitrogen gas. After the temperature was raised to 65° C., the polymerization reaction was carried out for 1 h to obtain 155 g of a polymerization product, with a catalyst activity of 1.94×10⁷ gPP/molcat·h, a molecular weight M_{W} of 23.5, a distribution of 2.1, and an isotacticity of 85%.

### Example 32

This Example was carried out under conditions as in Example 31, except that Z₂ was synthesized as follows:

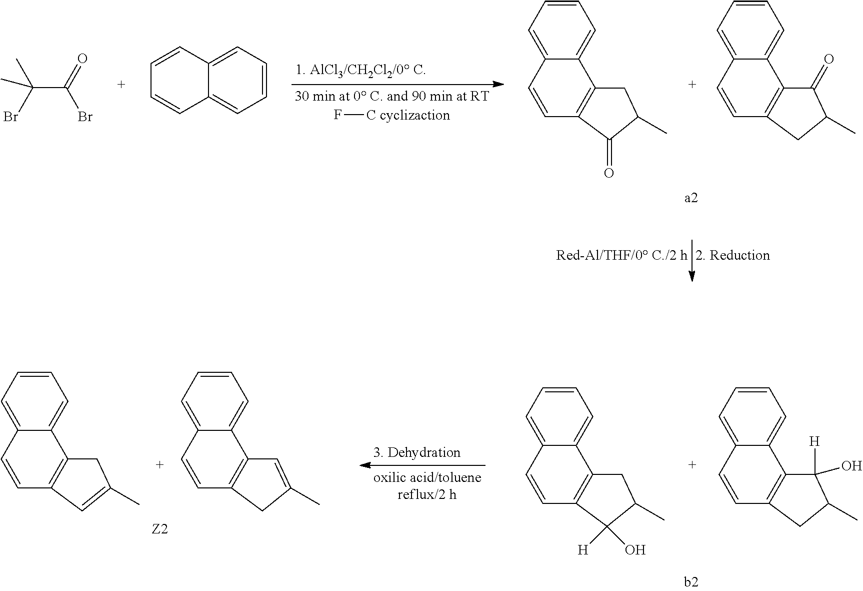

Synthesis of Intermediate a₂:

The raw materials were weighed according to calculation based on 1 mol of the product, and placed in a 2500 ml two-necked reaction flask, and then stirred in an ice-water bath for 20 mins. Dibromo-2-methylpropionyl bromide and anhydrous dichloromethane were weighed and added into a separating funnel, and slowly added dropwise into the reaction flask. Naphthalene and anhydrous dichloromethane were weighed and added to a separating funnel, rapidly dissolved, and then slowly added dropwise to the reaction system. The color of solution in the reaction flask quickly became yellow, and then gradually turned brown red. Then, anhydrous dichloromethane was added to rinse the separating funnel. The reaction was carried out for 30 min before ice was removed out and the temperature of the water bath slowly increased to room temperature. The reaction continued until emission of HBr gas was observed, which was regarded as the reaction endpoint. The resultant was washed with a large amount of water to remove impurities and unreacted raw materials, and the organic phase was collected upon liquid separation. The product in the water phase was extracted with anhydrous dichloromethane, which was repeated for three times. The extraction phase and the organic phase were combined and dried. The solvent was distilled off with a rotary evaporator to purify the crude product a₂, yield: 64.5%.

Synthesis of Intermediate b₂:

Intermediate a₂ was weighed and put into a 1000 ml two-necked reaction flask, 400 ml of THF was added thereto, and the flask was placed in an ice bath to be fully cooled; Red-Al was added dropwise over 15 mins. The reaction was carried out for 2 hours, warmed to room temperature, and continued at room temperature overnight. A 10% HCl solution was prepared and added dropwise to the reaction system, a white solid was precipitated and the system was made acidic. The resultant was suction-filtered by a Buchner funnel, and the organic phase was collected. The white solid was extracted twice with THF, and the extraction solution was collected. The organic phase and the extraction solution were combined and dried. A crude product was obtained by rotary-evaporation drying, with a yield of 68.4%.

Synthesis of Ligand Z₂:

Intermediate b₂ was dissolved in toluene, and oxalic acid and a 4 A molecular sieves were added thereto. The mixture was refluxed at 120° C. for 2 h. During the reaction, thin-layer chromatography was used to verify whether the reaction was complete. After the reaction was complete, the resultant was washed with an excessive amount of a bicarbonate solution, and then the organic phase was separated. The aqueous layer was extracted three times with ethyl acetate. The organic phase was combined and dried. The solvent was removed by rotary evaporation to give the ligand Z₂ with a yield of 84%. The final yield was 37.1%.

The polymerization reaction was carried out according to the conditions in Example 1, except that the zirconium dichloride complex was prepared by reaction using ligand Z₂ and ligand A₁, to obtain 460 g of the polymerization product, with a catalyst activity of 5.75×10⁷ gPP/molcat·h, a molecular weight M_{W} of 25.4, a distribution of 2.0, and an isotacticity of 66%.

### Example 33 to Example 54

22 zirconium dichloride complexes were obtained according to the conditions in Example 31 from the 22 ligands Z in Examples 4 to 24 and subjected to polymerization, and the results obtained are shown below.

| | Activities of | | Molcular | |
|---|---|---|---|---|
| | Catalysts × 10⁷ | Molecular | Weight | Isotacticity |
| Items | gPP/molcat · h | Weight M_{W} | Distribution | % |
| Example 33 | 10.25 | 29.3 | 1.9 | 75 |
| Example 34 | 0.34 | 19.3 | 2.1 | 53 |
| Example 35 | 0.55 | 21 | 2.0 | 61 |
| Example 36 | 1.02 | 21.2 | 2.3 | 65 |
| Example 37 | 2.10 | 18.5 | 2.2 | 69 |
| Example 38 | 52.25 | 30.5 | 2.0 | 75 |
| Example 39 | 3.55 | 24 | 2.1 | 90 |
| Example 40 | 20.35 | 26 | 2.0 | 85 |
| Example 41 | 4.05 | 20.5 | 1.9 | 88 |
| Example 42 | 0.06 | 25.5 | 2.0 | 48 |
| Example 43 | 0.15 | 22.5 | 2.0 | 51 |
| Example 44 | 0.84 | 16.5 | 1.9 | 55 |
| Example 45 | 12.45 | 28 | 2.0 | 86 |
| Example 46 | 0.85 | 23.5 | 2.0 | 75 |
| Example 47 | 1.26 | 24 | 2.1 | 78 |
| Example 48 | 6.45 | 25 | 2.0 | 81 |
| Example 49 | 0.56 | 19.5 | 1.9 | 68 |
| Example 50 | 9.55 | 26 | 2.0 | 78 |
| Example 51 | 5.25 | 20.5 | 1.9 | 80 |
| Example 52 | 6.45 | 23.4 | 2.0 | 89 |
| Example 53 | 10.25 | 17.5 | 2.0 | 70 |
| Example 54 | 7.50 | 15.8 | 1.9 | 65 |

### Example 55

This Example was carried out according to the procedures in Example 31, except that Compound A₁ was changed into a compound having a structure as below, with other conditions unchanged.

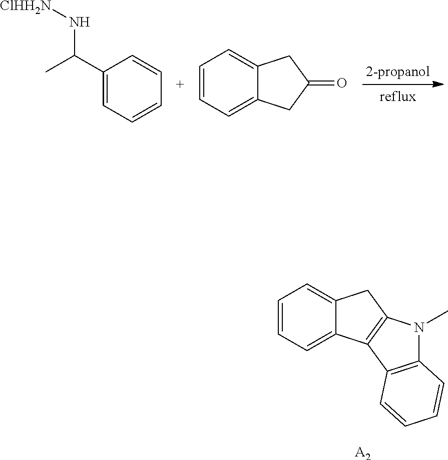

Synthesis of Compound A₂:

2.65 g of 2-indanone (20 mmol) was weighed and placed in a 250 ml two-necked flask, and then 100 mL of isopropyl alcohol was added thereto. The mixture was slowly stirred until the solid was completely dissolved. Then, 20 mmol of phenylhydrazine hydrochloride (1.0 equivalent) was slowly added. After the addition, the reaction mixture was stirred at room temperature for 30 mins and then slowly heated to reflux in an oil bath. The mixture was refluxed for 2 hours before the heating was discontinued, and then cooled to room temperature. A small amount of solid was precipitated.

Working-up: 50 mL of saturated sodium bicarbonate solution was prepared and slowly added to the above resulting solution, which was stirred continuously before a large amount of solid was precipitated, followed by filtration. The filter cake was then washed with a sodium bicarbonate solution and water to give 4.1 g brown solid, with a yield of 93%.

The polymerization was carried out according to the polymerization conditions in Example 1, except that 8 μmol of the zirconium dichloride complex obtained by using the compound having the structure of A₂ and the compound having the structure of Z₁, to obtain 134 g of a polymerization product, with a catalyst activity of 1.68×10⁷ gPP/molcat·h, a molecular weight M_{W} of 22, a distribution of 2.0, and an isotacticity of 88%.

### Example 56

This Example was carried out according to the procedures in Example 31, except that 30 g of 1-hexene was added in the polymerization process, to obtain 234 g of a polymerization product, with a catalyst activity of 2.93×10⁷ gPP/molcat·h, a molecular weight M_{W} of 19.5, a distribution of 2.4, and an isotacticity of 63%.

### Example 57

This Example was carried out according to the procedures in Example 31, except that 2.4 mmol of triisobutyl aluminium was added in the polymerization process, with the other conditions unchanged, to obtain 145 g of a polymerization product, with a catalyst activity of 1.81×10⁷ gPP/molcat·h, a molecular weight M_{W} of 26.5, a distribution of 2.1, and an isotacticity of 85%.

### Example 58

This Example was carried out according to the procedures in Example 31, except that the metallocene complex with the π-ligand was synthesized at a reaction temperature of −75° C., with the other conditions unchanged, to obtain 145 g of a polymerization product, with a catalyst activity of 0.61×10⁷ gPP/molcat·h, a molecular weight M_{W} of 22.5, a distribution of 2.0, and an isotacticity of 86%.

### Example 59

This Example was carried out according to the procedures in Example 31, except that, in the polymerization process, 2 L of dehydrated hexane was added and then a polymer-grade propylene was introduced, to obtain 65 g of a polymerization product, with a catalyst activity of 0.81×10⁷ gPP/molcat·h, a molecular weight M_{W} of 25.5, a distribution of 2.2, and an isotacticity of 86%.

### Example 60

This Example was carried out according to the procedures in Example 31, except that the metallocene complex with the π-ligand was synthesized at a reaction temperature of 150° C., with the other conditions unchanged, to obtain 220 g of a polymerization product, with a catalyst activity of 2.75×10⁷ gPP/molcat·h, a molecular weight M_{W} of 24, a distribution of 2.1, and an isotacticity of 85%.

The present invention may of course be implemented in other various embodiments, and all sort of variations and modifications made by those skilled in the art without departing from the spirit and essence of the present invention should be construed as falling within the scope of protection as defined in the appended claims.

1. A metallocene complex with a heteroatom-containing π-ligand, having a chemical structure represented by formula (I) as below: 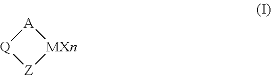
wherein M is a transition metal element from Group 3, Group 4, Group 5 and Group 6 in the periodic table, including lanthanides and actinides;
X, being the same as or different from each other, is selected from hydrogen, halogen, an alkyl group R, an alkoxyl group OR, a mercapto group SR, a carboxyl group OCOR, an amino group NR₂, a phosphino group PR₂, —OR^{o}O—, and OSO₂CF₃;
R is a linear or branched, saturated or unsaturated, halogenated or non-halogenated C₁-C₂₀ alkyl group, or C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group;
R^{o} is a divalent radical, including a C₂-C₄₀ alkylene group, a C₆-C₃₀ arylene group, a C₇-C₄₀ alkyl-substituted aryl group, a C₇-C₄₀ aryl-substituted alkyl group; in the structure of —OR^{o}O—, the two oxygen atoms are at any position of the radical, respectively;
n is an integer from 1 to 4 and is not zero; the charge number resulted from multiplying n by the charge number of X equals to the charge number of the central metal atom M minus 2;
Q is a divalent radical, including ═CR′₂, ═SiR′₂, ═GeR′₂, ═NR′, ═PR′, and ═BR′;
A is a π-ligand having a structure represented by chemical formula (II): 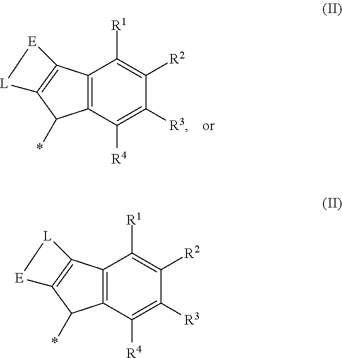
Z is a π-ligand, with Z having a chemical structure represented by the following chemical formulae (X), (XI), (XII), (XIII), (XIV) or (XV): 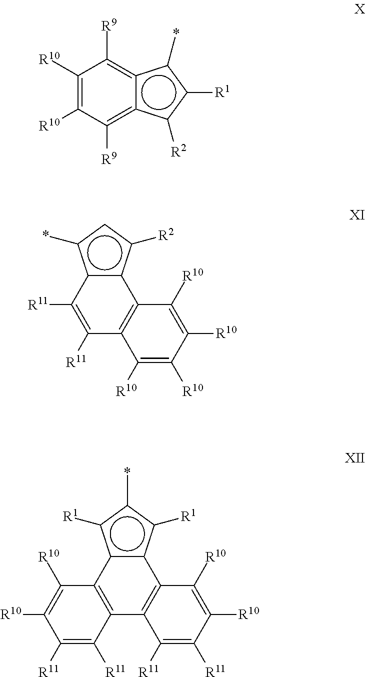 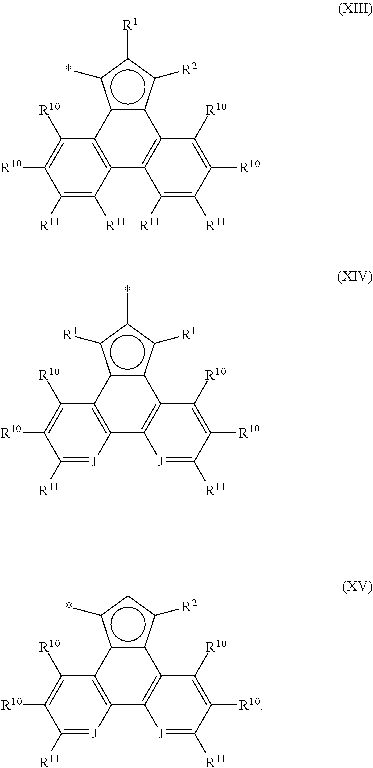
the symbol * in chemical formula (II), (X), (XI), (XII), (XIII), (XIV) and (XV) is linked to a chemical bond, an atom or a radical, indicating that the site linked to * forms a chemical single bond with a chemical bond, atom or radical of the same kind.

2. The metallocene complex with a heteroatom-containing π-ligand according to claim 1, characterized in that, in chemical formula (I), A is a monovalent anionic π-ligand having a chemical structure represented by chemical formula (II)-Li⁺; chemical formula (II) contains a basic structure having a cyclopentadienyl ring, while the active hydrogen in the cyclopentadienyl structure has electrophilic reactivity and can react with a nucleophilic agent in an exchange reaction to produce the compound represented by chemical formula (II)-Li⁺, and the essential reaction thereof is shown by the reaction equation (2):

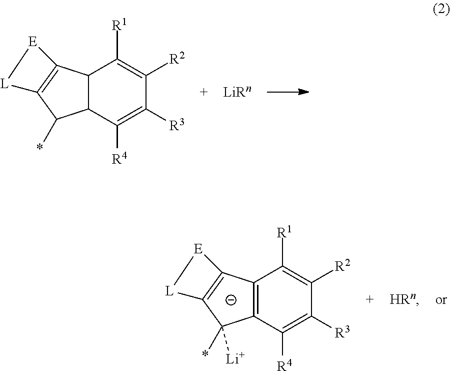

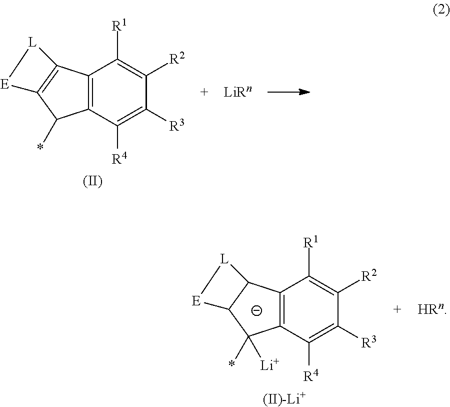

3. The metallocene complex with a heteroatom-containing π-ligand according to claim 2, characterized in that, the nucleophilic agent in the reaction equation (2) is an organolithium agent RⁿLi, wherein Rⁿ is a C₁-C₆ alkyl group or a C₆-C₁₂ aryl group.

4. The metallocene complex with a heteroatom-containing π-ligand according to claim 1, characterized in that, M is zirconium, hafnium or titanium from Group 4.

5. (canceled)

6. (canceled)

7. The metallocene complex with a heteroatom-containing π-ligand according to claim 1, characterized in that, in the structure of —OR^{o}O—, the combination of the positions of the two oxygen atoms are ortho-α,β-positions or meta-α,γ-positions in the radical.

8. The metallocene complex with a heteroatom-containing π-ligand according to claim 1, characterized in that, X is chloro, bromo, a C₁-C₂₀ lower alkyl group, or an aryl group.

9. The metallocene complex with a heteroatom-containing π-ligand according to claim 1, characterized in that, R′, being the same or different, is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group.

10. The metallocene complex with a heteroatom-containing π-ligand according to claim 9, characterized in that, R′ is methyl, ethyl, isopropyl, trimethylsilyl, phenyl, or benzyl.

11. (canceled)

12. The metallocene complex with a heteroatom-containing π-ligand according to claim 1, characterized in that, E in chemical formula (II) is a divalent radical having an element from Group 15 or 16 in the periodic table, including an oxygen radical, a sulfur radical, a selenium radical, NR″ and PR″;
L is a divalent radical and has the following structures represented by chemical formulae (III), (IV), (V), (VI), (VII) or (VIII): 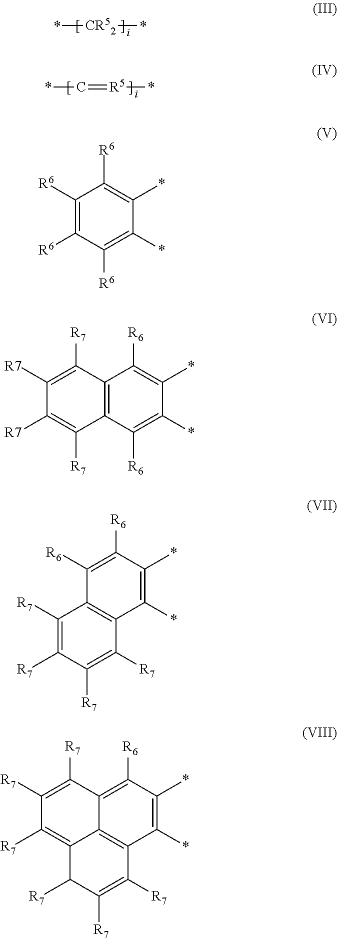
the symbol * is linked to a chemical bond, an atom or a radical, indicating that the site linked to * forms a chemical single bond with a chemical bond, atom or radical of the same kind;
R¹ is hydrogen, a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group;
R² and R³ are independently hydrogen, fluoro, or R, wherein R is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group;
R⁴ is hydrogen, a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group;
R⁹, being the same or different, is a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group;
R¹⁰, being the same or different, is hydrogen, a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group;
R¹¹, being the same or different, is hydrogen, fluoro, chloro, bromo, OR, SR, OCOR, NR₂, or PR₂, wherein R is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group; or R¹¹ is a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group;
J is an element of Group 13 or 15 in the periodic table, including boron, aluminum, gallium, nitrogen, phosphorus, and arsenic.

13. The metallocene complex with a heteroatom-containing π-ligand according to claim 12, characterized in that, R″ is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group.

14. The metallocene complex with a heteroatom-containing π-ligand according to claim 12, characterized in that, R″ is a C₄-C₁₀ linear alkyl, phenyl, mono- or poly-substituted phenyl, benzyl, mono- or poly-substituted benzyl, 1-naphthyl, 2-naphthyl, 2-anthryl, 1-phenanthryl, 2-phenanthryl, or 5-phenanthryl.

15. (canceled)

16. The metallocene complex with a heteroatom-containing π-ligand according to claim 12, characterized in that, R¹ is hydrogen, methyl, ethyl, isopropyl, t-butyl, phenyl, benzyl, 2-furyl, or 2-thienyl.

17. (canceled)

18. (canceled)

19. The metallocene complex with a heteroatom-containing π-ligand according to claim 12, characterized in that, R⁴ is H, methyl, trifluoromethyl, isopropyl, t-butyl, phenyl, p-tert-butylphenyl, p-trimethylsilylphenyl, p-trifluoromethylphenyl, 3,5-dichloro-4-trimethylsilylphenyl, or 2-naphthyl.

20. The metallocene complex with a heteroatom-containing π-ligand according to claim 7, characterized in that, the heteroatom from Groups 13 to 17 in the periodic table is boron, aluminum, silicon, germanium, sulfur, oxygen, fluorine, or chlorine.

21. (canceled)

22. (canceled)

23. The metallocene complex with a heteroatom-containing π-ligand according to claim 12, characterized in that, in formulae (III) and (IV), i is an integer and i is not zero;
R⁵, being the same or different, is a saturated or unsaturated, halogenated or non-halogenated C₁-C₄₀ alkyl group, or a C₁-C₄₀ alkyl group including a heteroatom from Groups 13 to 17 in the periodic table, a C₃-C₄₀ cycloalkyl group, a C₆-C₄₀ aryl group, a C₇-C₄₀ alkyl-substituted aryl group, or a C₇-C₄₀ aryl-substituted alkyl group;
R⁶ and R⁷ in chemical formulae (V), (VI), (VII) and (VIII) are independently hydrogen, fluoro, or R, wherein R is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group.

24. The metallocene complex with a heteroatom-containing π-ligand according to claim 23, characterized in that, in formulae (III) and (IV), i is 2.

25. (canceled)

26. The metallocene complex with a heteroatom-containing π-ligand according to claim 23, characterized in that, R⁵ is hydrogen, fluoro, or methyl.

27-33. (canceled)

34. The metallocene complex with a heteroatom-containing π-ligand according to claim 1, characterized in that, R⁹ is a linear or branched, saturated or unsaturated, partially or wholly halogenated, or linear or cyclic C₁-C₂₀ carbon radical.

35. (canceled)

36. The metallocene complex with a heteroatom-containing π-ligand according to claim 10, characterized in that, R¹⁰ is hydrogen, fluoro, chloro, methyl, ethyl, or phenyl.

37. (canceled)

38. (canceled)

39. The metallocene complex with a heteroatom-containing π-ligand according to claim 10, characterized in that, J is nitrogen or phosphorus.

40. A catalyst system of a metallocene complex with a heteroatom-containing π-ligand, comprising a compound represented by chemical formula (Ia) which is prepared from the metallocene complex (I) according to claim 1 via the activation reaction as shown by the reaction equation (1): 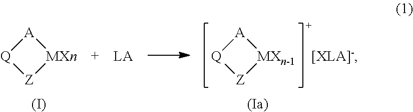
wherein, LA is a Lewis acid substance.

41. The catalyst system of a metallocene complex with a heteroatom-containing π-ligand according to claim 40, characterized in that, LA is a polymethylaluminoxane or modified polymethylaluminoxane having simultaneously chain-, cyclic- and cage-like structures in equilibrium in a solution.

42. The catalyst system of a metallocene complex with a heteroatom-containing π-ligand according to claim 40, characterized in that, the activation reaction is completed in a homogeneous liquid medium comprising a saturated-alkane liquid medium and an aromatic liquid medium, wherein the saturated alkane includes pentane and isomers thereof, hexane and isomers thereof, heptane and isomers thereof, as well as octanes and isomers thereof, and the aromatic liquid media includes benzene, toluene, xylene and isomers thereof, trimethylbenzene and isomers thereof, chlorobenzene, dichlorobenzene and isomers thereof, fluorobenzene, difluorobenzene and isomers thereof, as well as polyfluorobenzene and isomers thereof.

43. The catalyst system of a metallocene complex with a heteroatom-containing π-ligand according to claim 40, characterized in that, the homogeneous liquid medium used in the activation reaction is a mixed liquid medium of two or more liquid media, wherein the mixed liquid medium refers to a mixture of the saturated alkane and the aromatic hydrocarbon mixed in such a volume ratio in percentage that the volume percentage of one of the liquid media is a not lower than 5%.

44. The catalyst system of a metallocene complex with a heteroatom-containing π-ligand according to claim 40, characterized in that, the activation reaction is completed at a temperature in the range of −100° C. to +250° C., with the yield of the reaction product (Ia) being 95% or more.

45. The catalyst system of a metallocene complex with a heteroatom-containing π-ligand according to claim 40, characterized in that, the reaction temperature of the activation reaction is between −75° C. and 150° C.

46. A process for synthesizing the metallocene complex with a heteroatom-containing π-ligand according to claim 1, characterized in that, the process is represented by the following reaction equation (3) of the heteroatom-containing π-ligand: 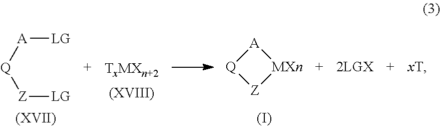
wherein, T, being the same as or different from each other, is a monodentate or bidentate neutral ligand;
LG is a leaving group, same as or different from each other, being hydrogen, an alkali metal element or an organic radical of a Group 14 heavy element.

47. The process for synthesizing the metallocene complex with a heteroatom-containing π-ligand according to claim 46, characterized in that, the monodentate ligand includes ethers (ROR), thioethers (RSR), tertiary amines (NR₃), tertiary phosphines (PR₃), cyclic ethers, cyclic thioethers, ketones, substituted cyclic ketones, substituted pyridines, substituted pyrroles, substituted piperazines, esters, lactones, amides and lactams, wherein R is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group;
the bidentate ligand includes ortho-diethers, α,ω̅-diethers, ortho-diamines, α,ω̅-diamines, ortho-disulfides, α,ω̅-disulfides, ortho-bisphosphines, and α,ω̅-bisphosphines;
x is 0 or an integer of 1, 2 or 3.

48. (canceled)

49. (canceled)

50. The process for synthesizing the metallocene complex with a heteroatom-containing π-ligand according to claim 46, characterized in that, the alkali metal element includes lithium, sodium and potassium; the organic radical of a Group 14 heavy element includes SiR₃, GeR₃, SnR₃, PdR₃, ZnR, BaR, MgR and CaR, wherein R is a linear or branched, saturated or unsaturated, halogenated or non-halogenated C₁-C₂₀ alkyl group, or a C₁-C₂₀ alkyl group including a heteroatom from Groups 13 to 17 in the periodic table, a C₃-C₂₀ cycloalkyl group, a C₆-C₃₀ aryl group, a C₇-C₃₀ alkyl-substituted aryl group, or a C₇-C₃₀ aryl-substituted alkyl group.

51. The process for synthesizing the metallocene complex with a heteroatom-containing π-ligand according to claim 46, characterized in that, in the synthesis process, the reaction medium is a saturated C₅-C₁₅ alkane, cycloalkane or a mixture of two or more thereof.

52. The process for synthesizing the metallocene complex with a heteroatom-containing π-ligand according to claim 46, characterized in that, in the synthesis process, the reaction medium is hexane, heptane, octane, toluene, or xylene.

53. The process for synthesizing the metallocene complex with a heteroatom-containing π-ligand according to claim 46, characterized in that, the reaction temperature is in the range of −100° C. to +300° C.

54. The process for synthesizing the metallocene complex with a heteroatom-containing π-ligand according to claim 46, characterized in that, the reaction temperature is in range of −75° C. to +250° C.

55. The process for synthesizing the metallocene complex with a heteroatom-containing π-ligand according to claim 46, characterized in that, the reaction temperature is in the range of −50° C. to +150° C.

56. Use of the catalyst system of a metallocene complex with a heteroatom-containing π-ligand according to claim 40 in catalysis of polymerization or copolymerization of α-olefins under the process conditions of bulk slurry or solvent slurry polymerization.
